(19) United States
(12) Patent Application Publication
(10) Pub. No.: US 2009/0266428 A1
(43) Pub. Date: Oct. 29, 2009

(54) FLUID CONTROL SYSTEM

(75) Inventors: Kenro Yoshino, Miyazaki (JP); Takashi Yamamoto, Miyazaki (JP)

Correspondence Address: BUCHANAN, INGERSOLL & ROONEY PC, POST OFFICE BOX 1404, ALEXANDRIA, VA, 22313-1404, US

(73) Assignee: ASAHI ORGANIC CHEMICALS INDUSTRY CO., LTD., Nobeoka-shi (JP)

(21) Appl. No.: 12/064,415

(22) PCT Filed: Aug. 21, 2006
(86) PCT No.: PCT/JP2006/316784

§ 371 Date: Feb. 21, 2008

(30) Foreign Application Priority Data
Aug. 22, 2005 (JP) 2005-240448

(51) Int. Cl. F16K 37/00

(52) U.S. Cl. 137/551

(57) ABSTRACT

The fluid control system according to the present invention is characterized by being provided with a fluid control valve changing an opening area of a passage so as to control a flow rate of a fluid, a flow rate measuring device measuring a flow rate of the fluid, converting a measurement value of said flow rate to an electrical signal, and outputting it, and a control part outputting a command signal for controlling an opening area of said fluid control valve to said fluid control valve or a piece of equipment operating said fluid control valve based on a difference between the electrical signal from the flow rate measuring device and a set flow rate as a first characterizing feature.

### TECHNICAL FIELD

The present invention relates to a fluid control system used for a fluid transport pipe where fluid control is required. More particularly, it relates to a fluid control system mainly installed in a semiconductor production facility etc., facilitating piping and wiring, enabling control of the flow rate without problem even when a pulsating fluid is flowing, and enabling stable, precision control of the flow rate over a broad flow rate range.

### BACKGROUND ART

In the past, as one step in the process of production of semiconductors, wet etching using a washing solution comprised of fluoric acid or another chemical diluted by pure water to etch the surface of a wafer has been used. It is considered necessary to manage the concentration of the washing solution of the wet etching with a high precision. In recent years, the method of managing the concentration of the washing solution by the ratio of flow rates of the pure water and chemical has become the mainstream. For this reason, a fluid control system managing the flow rate of pure water or chemicals with a high precision has been applied.

Various fluid control systems have been proposed. There has been a control system 301 of the flow rate of pure water which controls the flow rate when making the temperature of the pure water variable such as shown in FIG. 19 (for example, see Japanese Patent Publication (A) No. 11-161342). This was configured as a control system 301 provided with a flow rate adjusting valve 302 adjusted in opening degree when receiving the action of operating pressure for adjusting a flow rate of pure water, an operating pressure adjusting valve 303 for adjusting the operating pressure supplied to the flow rate adjusting valve 302, a flow rate measuring device 304 for measuring the flow rate of pure water output from the flow rate adjusting valve 302, and a shutoff valve 305 for allowing or cutting off the flow of pure water passing through the flow rate measuring device 304, which balanced the operating pressure adjusted by the operating pressure adjusting valve 303 and the outlet pressure of the pure water at the flow rate adjusting valve 302 so as to control the flow rate of the pure water output from the flow rate adjusting valve 302 to be constant, characterized by making the measurement value by the flow rate measuring device 304 become constant by providing a control circuit for feedback control of the operating pressure supplied from the operating pressure adjusting valve 303 to the flow rate adjusting valve 302 based on that measurement value. The effect was that even if the output pressure at the flow rate adjusting valve 302 changed along with a change of temperature of the pure water, the operating pressure was adjusted in real time according to that change whereby the flow rate of the pure water output from the flow rate adjusting valve 302 was adjusted, so the flow rate of the pure water could be maintained at a constant value at a high precision.

Further, as a fluid control system based on electrical drive with parts provided inside a single casing, there was a fluid control module 306 as shown in FIG. 20 connected in-line to a fluid circuit transporting a fluid (for example, see Japanese Patent Publication (A) No. 2001-242940). This was configured by provision of a housing 307 having a chemically inert passage, an adjustable control valve 308 connected to the passage, a pressure sensor 309 connected to the passage, and a constricted part 310 positioned in the passage, the control valve 308 and the pressure sensor 309 housed in the housing 307, and further having a driver 311 provided with an electric motor for electrically driving the control valve 308 and a controller 312 electrically connected to the control valve 308 and the pressure sensor 309 housed in the housing 307. The effect was that by measuring the flow rate in the passage from the pressure difference measured in the fluid circuit and the diameter of the constricted part 310 and driving the control valve 308 by feedback control based on the measured flow rate, it was possible to determine the flow rate in the passage with a high precision.

However, said conventional pure water flow rate control system 301 balanced with the outlet pressure of the pure water at the flow rate adjusting valve 302 so as to control the flow rate of the pure water output from the flow rate adjusting valve 302 to a constant value, so was not suited to fine control of the flow rate. The flow rate range was also not that wide, so there was the problem that this was hard to use for applications controlling the flow rate over a broad flow rate range. Further, the components are split into numerous parts, so when installing the system inside a semiconductor production facility etc., it was necessary to perform work for connecting the piping among the components and the work of electrical wiring and air piping. The work was complicated and required time. Further, the piping and wiring were troublesome and mistakes were liable to be made.

Further, said conventional flow rate control module 306 had the problem that when the fluid flowing into the fluid control system was a pulsating flow with a short period of fluctuation of pressure, the control valve 308 would operate to try to control the flow rate for the pulsating fluid, but there was the problem that hunting would occurred and flow rate control would no longer be possible and, if continued as is, the driver 311 or the control valve 308 would end up breaking down. Further, the flow rate range for control of the flow rate was not that wide, so there was the problem that this was hard to use for applications controlling the flow rate over a broad flow rate range.

### DISCLOSURE OF THE INVENTION

The present invention was made in consideration of the above problems in the prior art and has as its object the provision of a fluid control system facilitating installation, piping, and wiring in a semiconductor production facility etc., enabling control of the flow rate without problem even when a pulsating fluid flows, and enabling stable, precision control of the flow rate over a broad flow rate range.

Explaining the configuration of the fluid control system of the present invention for solving the above problems based on the figures, this is provided with a fluid control valve 4 changing an opening area of a passage so as to control a flow rate of a fluid, a flow rate measuring device 3 measuring a flow rate of the fluid, converting a measurement value of said flow rate to an electrical signal, and outputting it, and a control part 6 outputting a command signal for controlling an opening area of said fluid control valve to said fluid control valve or a piece of equipment operating said fluid control valve based on a difference between the electrical signal from the flow rate measuring device and a set flow rate as a first characterizing feature.

Further, the device is further provided with a shutoff valve 61 for opening or cutting off the flow of the fluid as a second characterizing feature.

Further, the device is further provided with a pressure adjustment valve 83 reducing pressure fluctuations of said fluid as a third characterizing feature.

Further, said valves 4, 61, and 83 and said flow rate measuring device 3 are directly connected without using independent connecting means as a fourth characterizing feature. The “independent connecting means” mean separate tubes, connecting pipes, etc.

Further, said valves 4, 61, and 83 and said flow rate measuring device 3 are arranged in a single base block 146 as a fifth characterizing feature.

Further, said fluid control valve 85 is provided with a main body having a valve chamber at its top part and an inlet passage and outlet passage communicating with the valve chamber and provided with an opening part to which the inlet passage is communicated at the center of the bottom part of the valve chamber, a cylinder provided with a through hole at the center of the bottom part and a breathing hole at a side surface and clamping and fastening the main body and first diaphragm, and a bonnet provided with a working fluid communication port at the top part and clamping and fastening the cylinder and the peripheral edge of the second diaphragm all fastened integrally; the first diaphragm is formed integrally by a shoulder part, a mounting part positioned on the shoulder part and fastened by engagement with a bottom part of a later mentioned rod, a connecting part positioned below the shoulder part and to which a later mentioned valve element is fastened, a thin film part extending in the radial direction from the shoulder part, a thick part following the thin film part, and a seal part provided at the peripheral edge of the thick part, the connecting part having fastened to it a valve element emerging and retracting along with up and down motion of a later mentioned rod at the opening part of the valve chamber; on the other hand, the second diaphragm has a center hole, is integrally formed with a thick part around it and thin film part extending from the thick part in the radial direction and a seal part provided at the peripheral edge of the thin film part, and is clamped and fastened passing through the center hole by a diaphragm holder at a shoulder part positioned at the top part of the rod to which the mounting part of the first diaphragm is fastened at the bottom part; and further the rod has a bottom part arranged in a loosely engaged state inside the through hole at the bottom part of the cylinder and is supported by a spring engaged in a state preventing movement in the radial direction between the step part of the cylinder and the shoulder part of the rod as a sixth characterizing feature.

Note that the basic configuration of this control valve is disclosed in Japanese Patent Application No. 2004-252754.

Further, said fluid control valve 5 is comprised of a flow rate control unit provided with an electrical drive part having a motor part enclosed by an upper bonnet and lower bonnet, a diaphragm having a valve element moved up and down by a stem connected to a shaft of the motor part, and a main body having an inlet passage and outlet passage separated from the electrical drive part by a diaphragm and communicated with the valve chamber as a seventh characterizing feature.

Note that the basic configuration of this control valve is disclosed in Japanese Patent Application No. 2004-252821.

Further, said fluid control valve 175 is provided with a pipe member comprised of an elastic member, a cylinder main body having an internal cylinder part and having a cylinder lid connected to its top part, a piston able to slide up and down at the inner circumferential surface of the cylinder part in a sealing state and having a connecting part provided suspended down from the center so as to pass through a through hole provided in the center of the bottom surface of the cylinder main body in a sealing state, a compressor fastened to a bottom end of the connecting part of the piston and housed in an elliptical slit provided perpendicularly intersecting the passage axis at the bottom surface of the cylinder main body, a main body connected and fastened to the bottom end face of the cylinder main body and provided with a first groove for receiving the pipe member on the passage axis and second grooves receiving a connecting member holder at the two ends of the first groove and deeper than the first groove, a pair of connecting member holders each having an engagement part for engagement with a second groove of the main body at one end, having a connecting member socket inside another end, and having a through hole for receiving a pipe member, and a pair of air ports provided at the peripheral side surfaces of the cylinder main body and communicating with a first space formed surrounded by the bottom surface and inner circumferential surface of the cylinder part and the bottom end surface of the piston and a second space formed surrounded by the bottom end surface of the cylinder, the inner circumferential surface of the cylinder part, and the top surface of the piston as an eighth characterizing feature.

Note that the basic configuration of this control valve is disclosed in Japanese Patent Publication (A) No. 2002-174352.

Further, said fluid control valve 185 is provided with an electrical drive part having a motor part enclosed by an upper bonnet and lower bonnet, a compressor driven up and down by a stem connected to a shaft of the motor part, a pipe member comprised of an elastic member, and a groove connected and fastened to a lower end face of the lower bonnet and housing a pipe member on a passage axis.

Note that the basic configuration of this control valve is disclosed in Japanese Patent Application No. 2004-252821.

Further, said pressure control valve 83 is provided with a main body having a second cavity provided at a center of the bottom part and opening at a base part, an inlet passage communicating with the second cavity, a first cavity provided at a top part with a top face open and having a diameter larger than a diameter of the second cavity, an outlet passage communicating with the first cavity, and a communicating hole communicating the first cavity and second cavity and having a diameter smaller than the diameter of the first cavity, a top face of the second cavity made a valve seat; a bonnet having inside it a cylindrical cavity communicating with an air feed hole and exhaust hole provided at a side face or top face and provided with a step part at an inner circumference of a bottom end; a spring retainer inserted into the step part of the bonnet and having a through hole at its center; a piston having at its bottom end a first connecting part with a smaller diameter than the through hole of the spring retainer, provided at its top part with a flange, and inserted inside the cavity of the bonnet to be vertically movable; a spring supported gripped by a bottom end face of the flange of the piston and a top end face of the spring retainer; a first valve mechanism having a first diaphragm having a peripheral edge fastened by being gripped between the main body and the spring retainer and having a center part forming a first valve chamber in a manner capping the first cavity of the main body made thick, a second connecting part provided at the center of its top face passing through the through hole of the spring retainer and fastened by being connected to the first connecting part of the piston, and a third connecting part provided at the center of its bottom face passing through the communicating hole of the main body; a second valve mechanism having a valve element positioned inside the second cavity of the main body and provided in a larger diameter than the communicating hole of the main body, a fourth connecting part provided sticking out at the top end face of the valve element and being fastened by being connected with the third connecting part of the first valve mechanism, a rod provided sticking out from a bottom end face of the valve element, and a second diaphragm provided extending out from the bottom end face of the rod in the radial direction; and a baseplate positioned below the main body, having at the center of its top part a projecting part fastening the peripheral edge of the second diaphragm of the second valve mechanism by gripping it with the main body, provided with a cut recess at a top end of the projecting part, and provided with a breathing hole communicating with the cut recess; an opening area of a fluid control part formed by the valve element of the second valve mechanism and the valve seat of the main body changing along with vertical motion of the piston as a 10th characterizing feature.

Note that the basic configuration of this control valve is disclosed in Japanese Patent Publication (A) No. 2004-38571.

Further, said pressure adjustment valve 111 is comprised of a main body having inside it a first valve chamber, a step part provided at the top part of the first valve chamber, and an inlet passage communicating with the first valve chamber; a lid having a second valve chamber and an outlet passage communicating with the same and connected to the top part of the main body; a first diaphragm with a peripheral edge connected to the upper peripheral edge of the first valve chamber; a second diaphragm with a peripheral edge clamped by the main body and lid; a sleeve connected to two ring-shaped connecting parts provided at the centers of the first and second diaphragms and able to move freely in the axial direction; and a plug fastened to the bottom part of the first valve chamber and forming a fluid control unit with the bottom end of the sleeve; there is an air chamber surrounded by an inner circumferential surface of the step part of the main body and the first and second diaphragms; a pressure receiving area of the second diaphragm is formed larger than a pressure receiving area of the first diaphragm; and an air supply communicating with said air chamber is provided at the main body as an 11th characterizing feature.

Note that the basic configuration of this control valve is disclosed in Japanese Patent Publication (A) No. 2003-29848.

Further, said flow rate measuring device 3 is an ultrasonic flowmeter or ultrasonic type vortex flowmeter as a 12th characterizing feature.

In the present invention, the fluid control valve 4 is not particularly limited so long as it enables a change of the opening area of the passage so as to control the flow rate, but one having the configuration of the fluid control valve 4 of the present invention controlling the flow rate of a fluid such as shown in FIG. 2, the fluid control valve 135 of the present invention controlling the flow rate of a fluid such as shown in FIG. 10, the flow control valve 175 of the present invention controlling the flow rate of a fluid such as shown in FIG. 12, or the fluid control valve 15 of the present invention controlling the flow rate of a fluid such as shown in FIG. 15 is preferable. This enables stable fluid control, enables the passage to be shut by just the fluid control valve 4, 135, 175, or 185, and enables a compact configuration and small fluid control system 1, so is preferable.

In the present invention, the flow rate measuring device 3 is not particularly limited so long as it converts the measured flow rate to an electrical signal and outputs it to the control part 6, but an ultrasonic flowmeter or ultrasonic type vortex flowmeter is preferable. In particular, in the case of the ultrasonic flowmeter such as shown in FIG. 1 or FIG. 16, a fine flow rate can be measured precisely, so this is preferable for fine flow rate fluid control. Further, in the case of the ultrasonic type vortex flowmeter as shown in FIG. 18, a large flow rate can be precisely measured, so this is preferable for large flow rate fluid control. In this way, by selectively using an ultrasonic flowmeter and ultrasonic type vortex flowmeter in accordance with the flow rate of the fluid, precise fluid control is possible.

Further, the present invention, as shown in FIG. 3, may also provide the fluid control system 59 with a shutoff valve 61. This is preferable since by providing the shutoff valve 61, it is possible to shut the shutoff valve 61 to facilitate maintenance, repair, and exchange of parts of the fluid control system 59 (hereinafter referred to as “maintenance etc.”) Further, if providing the fluid control system 59 with the shutoff valve 61, when shutting the passage and disassembling the fluid control system 59 for maintenance etc., it is possible to suppress to a minimum the leakage of fluid remaining in the passage from the disassembled parts. Furthermore, when some sort of trouble occurs in the passage, the shutoff valve 61 can cut off the fluid on an emergency basis, so this is preferred.

Further, the shutoff valve 61 is not particularly limited in its configuration so long as it has the function of opening or cutting off the flow of fluid. It may be manually operated or may be automatically operated by air, electricity, electromagnetic drive, etc. In the case of automatic operation, it is possible to provide a control circuit to link up with the fluid control valve 63 or flow rate measuring device 62 of the fluid control system 59 and drive the shutoff valve 61 in accordance with the state of the fluid control valve 63 or the flow rate or drive it independently from the fluid control system 59. If driven linked with the fluid control system 59, overall control in the fluid control system 59 is possible, so this is preferred. If driven independent of the fluid control system 59, when trouble occurs in the fluid control system 59 and the shutoff valve 61 is used to cut off the passage on an emergency basis, the valve can be driven without being affected by the trouble of the fluid control system 59, so this is preferred.

Further, for the installation position of the shutoff valve 61, for maintenance etc., installation at the upstream side of the other valve 63 and flow rate measuring device 62 is preferable. Furthermore, it is possible to provide shutoff valves 61 at both the upstream side and downstream side of the other valve 63 and flow rate measuring device 62. At this time, by closing both shutoff valves 61, the flows at the upstream side and the downstream side of the fluid control system 59 are stopped, so backflow of the fluid is prevented and leakage of fluid at the time of performing maintenance etc. is reliably prevented, so this is preferred.

Further, the present invention, as shown in FIG. 5, can provide the fluid control system 81 with a pressure adjustment valve 83. The pressure adjustment valve 83 is not particularly limited so long as it adjusts the pressure of the inflowing fluid to a constant pressure for outflow, but one having the configuration of the pressure adjustment valve 83 of the present invention such as shown in FIG. 6 is preferable. This is because it is compact in structure, can stabilize the pressure at a constant pressure by the pressure adjustment valve 83 even if the inflowing fluid is a flow pulsating with a fast pressure fluctuation period, and thereby can prevent the fluid control from becoming unable to be stably performed due to the effects of the pulsation.

In the fluid control system of the present invention, as shown in FIG. 1, FIG. 3, FIG. 5, and FIG. 7, the one or more valves and flow rate measuring device are preferably directly connected without using tubes, connecting pipes, or other independent connecting means. This is because by having the different components directly connected without using tubes or connecting pipes, the fluid control system can be made compact and the space taken up at the installation place can be reduced, the installation work becomes easy and the work time can be shortened, and the passage in the fluid control system can be shortened to the minimum required length, so the fluid resistance can be suppressed. At this time, the one or more valves and the main body of the flow rate measuring device may also be configured using the same base block. It is also possible to directly connect separate members with the interposition of connecting members 57 and 58 for sealing the passage and changing the direction of the passage. In the case of this configuration, maintenance of the flow rate measuring device 3 becomes particularly easy, so this is preferable.

In the fluid control system of the present invention, as shown in FIG. 8, the valves 140, 141, 143 and the flow rate measuring device 142 are preferably arranged in a single base block 146 formed in the passage. This is preferable since by arranging the components in a single base block 146, the fluid control system 138 can be made compact and the space taken up at the installation place can be reduced, the installation work becomes easy and the work time can be shortened, and the passage in the fluid control system 139 can be shortened to the minimum required length, so the fluid resistance can be suppressed. Furthermore, the number of parts can be reduced, so assembly of the fluid control system 138 can be facilitated, so this is preferable.

The order of arrangement of the flow rate measuring device, fluid control valve, shutoff valve, and pressure adjustment valve of the present invention may be any order and is not particularly limited, but the pressure adjustment valve is preferably positioned at the upstream side of the fluid control valve and flow rate measuring device. This is because when the fluid has pressure pulsation, it is preferable to attenuate the pulsation at the initial stage. Further, it is more preferable to position the fluid control valve at the upstream side of the flow rate measuring device. This is because it is possible to measure the net flow rate in the final stage.

Further, the fluid control system of the present invention may be used for any application where it is necessary to control the flow rate of the fluid to be constant by any value, but is suitably placed in a semiconductor production facility. As front-end steps in the process of production of semiconductors, a photoresist coating step, pattern exposure step, etching step, flattening step, etc. may be mentioned. When managing the concentrations of these washings by the ratio of flow rates of pure water and the chemicals, the fluid control system of the present invention is preferably used.

Further, the parts of the flow rate measuring device, fluid control valve, shutoff valve, and throttle valve of the present invention, if made from a resin, may be polyvinyl chloride, polypropylene (hereinafter referred to as “PP”), polyethylene, etc., but when a corrosive fluid is used as the fluid, polytetrafluoroethylene (hereinafter referred to as “PTFE”), polyvinylidene fluoride (hereinafter referred to as “PVDF”), tetrafluoroethylene-perfluoroalkylvinyl ether copolymer resin (hereinafter referred to as “PFA”), or another fluororesin is preferable. If made of a fluororesin, use for a corrosive fluid is possible. Further, even if a corrosive gas passes through them, there is no longer any concern over corrosion of the valves and flow rate measuring device, so this is preferable.

The present invention is structured as explained above and gives the following superior effects:

(1) By using the fluid control system for feedback control, it is possible to stabilize the flow rate of the fluid to a set flow rate with a good response.

(2) The components of the fluid control system are directly connected without using tubes, connecting pipes, or other independent connecting means, so the fluid control system can be made compact and the space of the installation location can be reduced, the installation work becomes easy and the work time can be shortened, and the passage inside the fluid control system can be shortened to the minimum necessary extent, so the fluid resistance can be kept down.

(3) By arranging the fluid control system in a single base block formed with a passage, the fluid control system can be made compact and the space at the installation location can be reduced, the installation work becomes easy and the work time can be shortened, and the passage in the fluid control system can be shortened to the minimum necessary limit, so the fluid resistance can be kept down. Furthermore, the number of parts can be reduced, so assembly of the fluid control system can be facilitated.

(4) By using the fluid control valve of the configuration of the present invention, stable fluid control is possible. Even if a pulsating fluid flows, the fluid control valve can be used to stabilize the pressure or flow rate to a constant one. The fluid control valve alone is enough for opening and closing the passage and the configuration is compact, so the fluid control system can be provided small.

(5) By providing the fluid control system with a shutoff valve, it is possible to close the shutoff valve so as to maintain, repair, and replace parts of the fluid control system easily without leakage of fluid and possible to use the shutoff valve to cut off the fluid on an emergency basis when some sort of trouble occurs in the passage.

(6) By providing the fluid control system with a pressure adjustment valve, it is possible to cause the pulsation to attenuate by the pressure adjustment valve even if a pulsating fluid flows.

Below, the present invention will be able to be more sufficiently understood from the attached drawings and the description of the preferred embodiments of the present invention.

### BRIEF DESCRIPTION OF THE DRAWINGS

FIG. 1 is a vertical cross-sectional view of a fluid control system showing a first embodiment of the present invention.

FIG. 2 is an enlarged view of a fluid control valve of FIG. 1.

FIG. 3 is a vertical cross-sectional view of a fluid control system showing a second embodiment of the present invention.

FIG. 4 is an enlarged view of a shutoff valve of FIG. 2.

FIG. 5 is a vertical cross-sectional view of a fluid control system showing a third embodiment of the present invention.

FIG. 6 is an enlarged view of a fluid adjustment valve of FIG. 5.

FIG. 7 is a vertical cross-sectional view of a fluid control system showing a fourth embodiment of the present invention.

FIG. 8 is a vertical cross-sectional view of a fluid control system showing a fifth embodiment of the present invention.

FIG. 9 is a vertical cross-sectional view of a fluid control system showing a sixth embodiment of the present invention.

FIG. 10 is an enlarged view of a fluid control valve of FIG. 9.

FIG. 11 is a vertical cross-sectional view of a fluid control system showing a seventh embodiment of the present invention.

FIG. 12 is an enlarged view of a fluid control valve of FIG. 11.

FIG. 13 is an enlarged view of a pressure adjustment valve of FIG. 11.

FIG. 14 is a vertical cross-sectional view of a fluid control system showing an eighth embodiment of the present invention.

FIG. 15 is an enlarged view of a fluid control valve of FIG. 14.

FIG. 16 is a vertical cross-sectional view of a fluid control system showing a ninth embodiment of the present invention.

FIG. 17 is a vertical cross-sectional view of a fluid control system showing a 10th embodiment of the present invention.

FIG. 18 is a cross-sectional view along the line A-A of FIG. 17.

FIG. 19 is a conceptual view of the configuration showing a conventional pure water flow rate control system.

FIG. 20 is a partial cross-sectional view showing a conventional fluid control module.

### BEST MODE FOR CARRYING OUT THE INVENTION

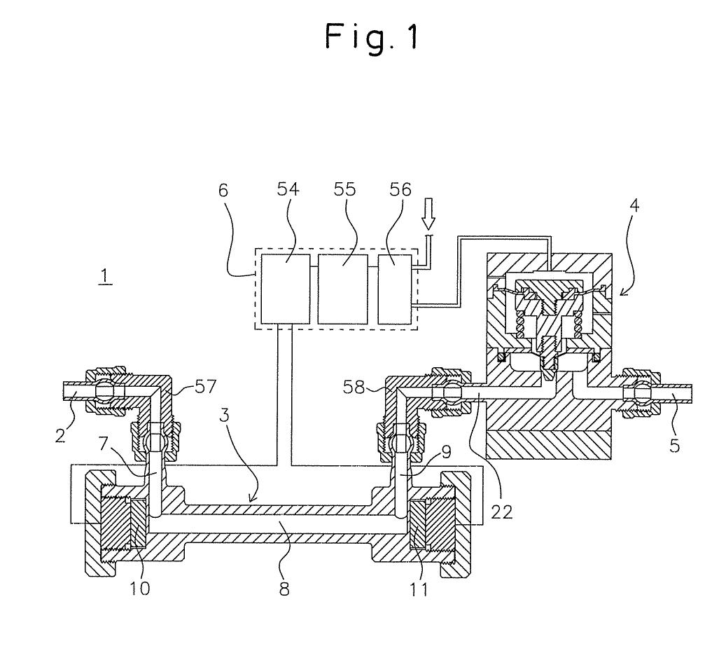

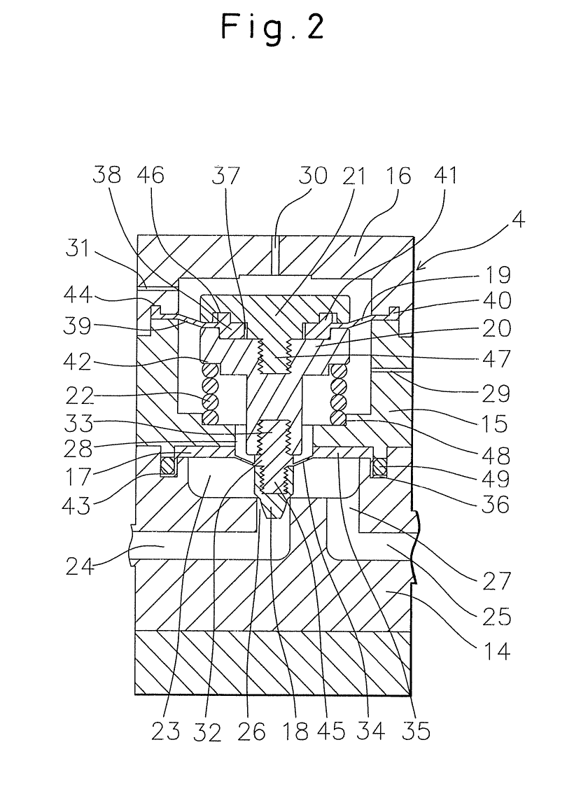

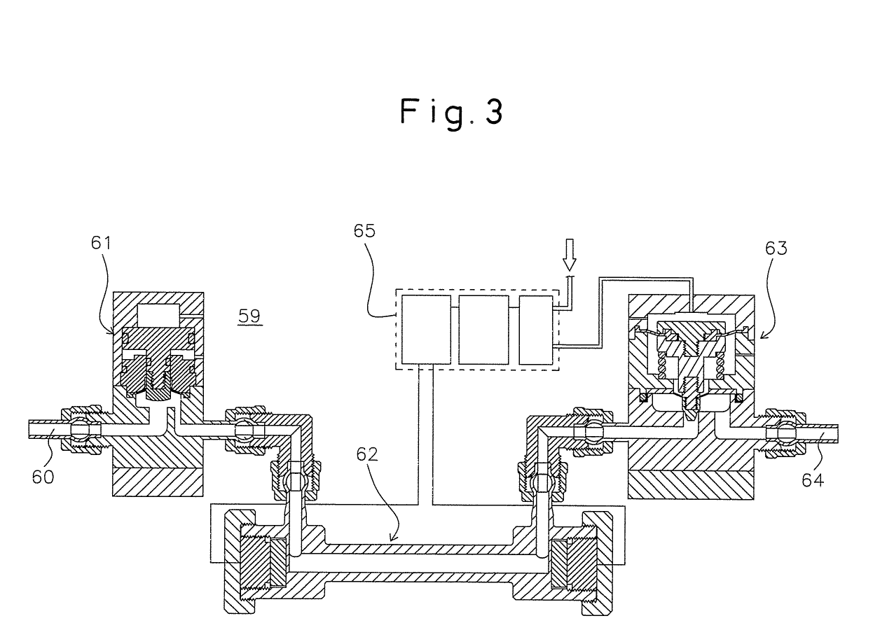

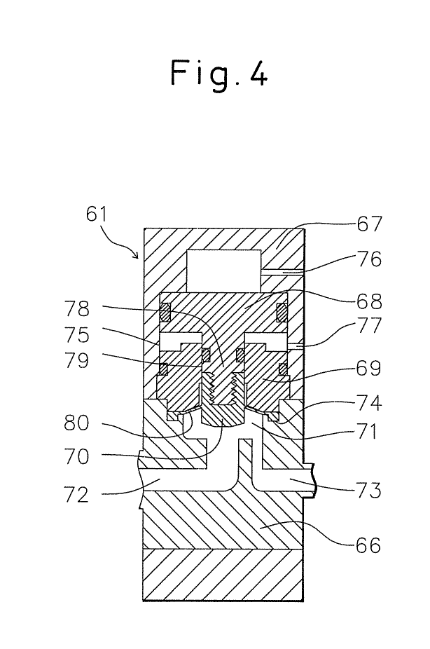

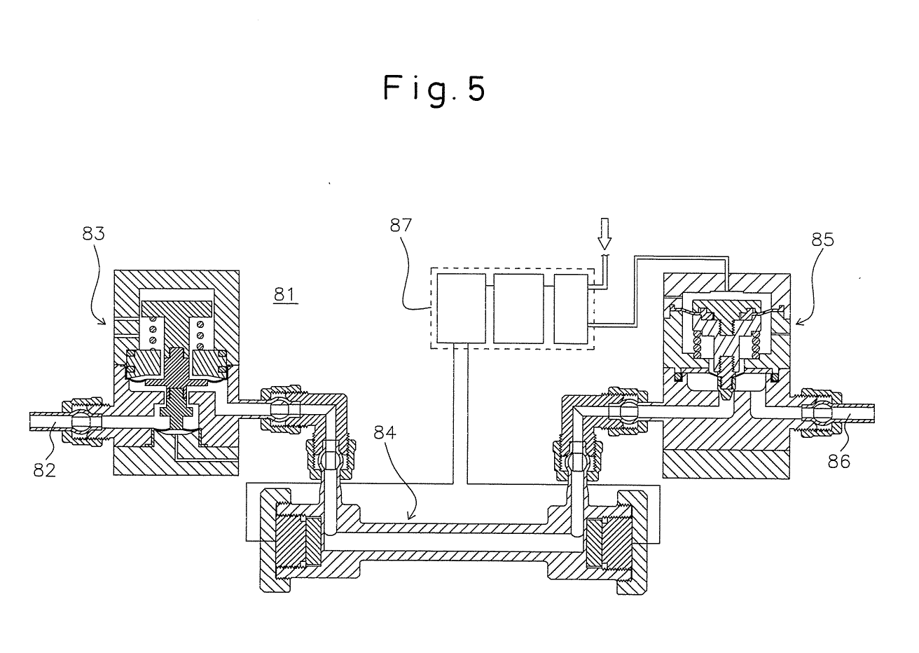

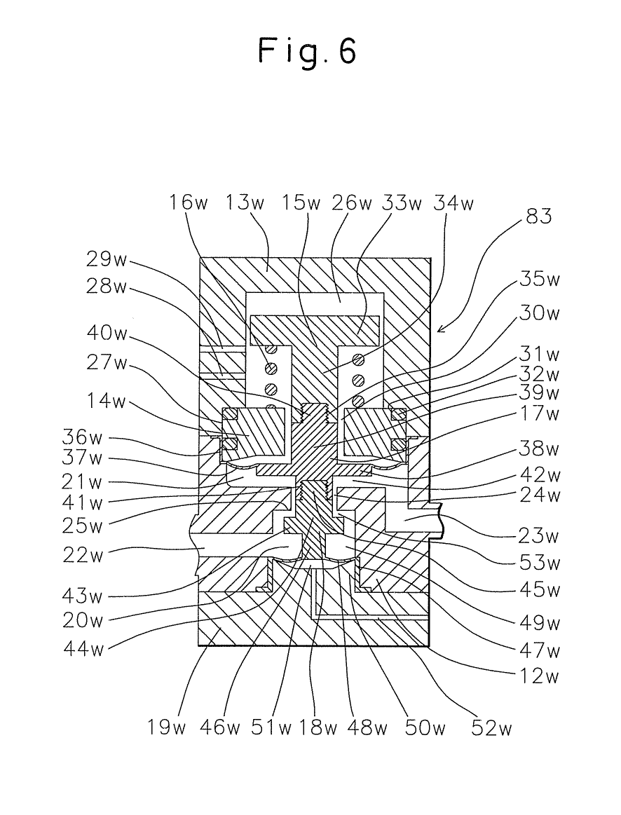

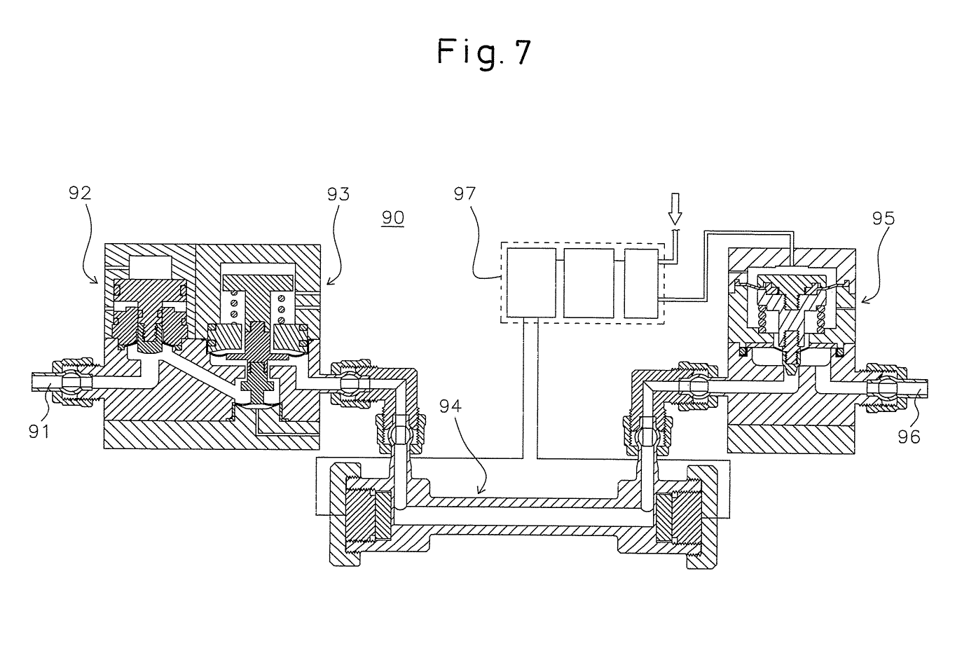

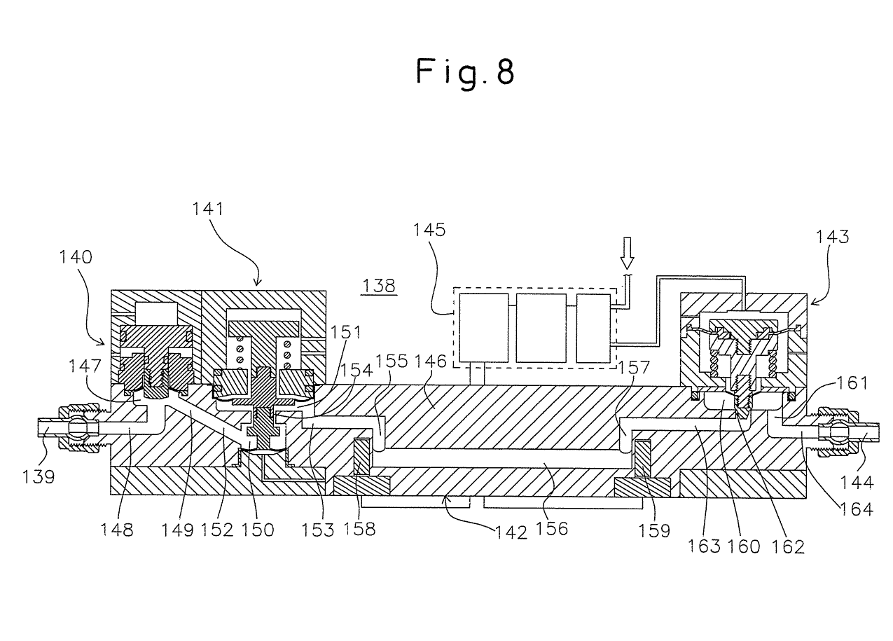

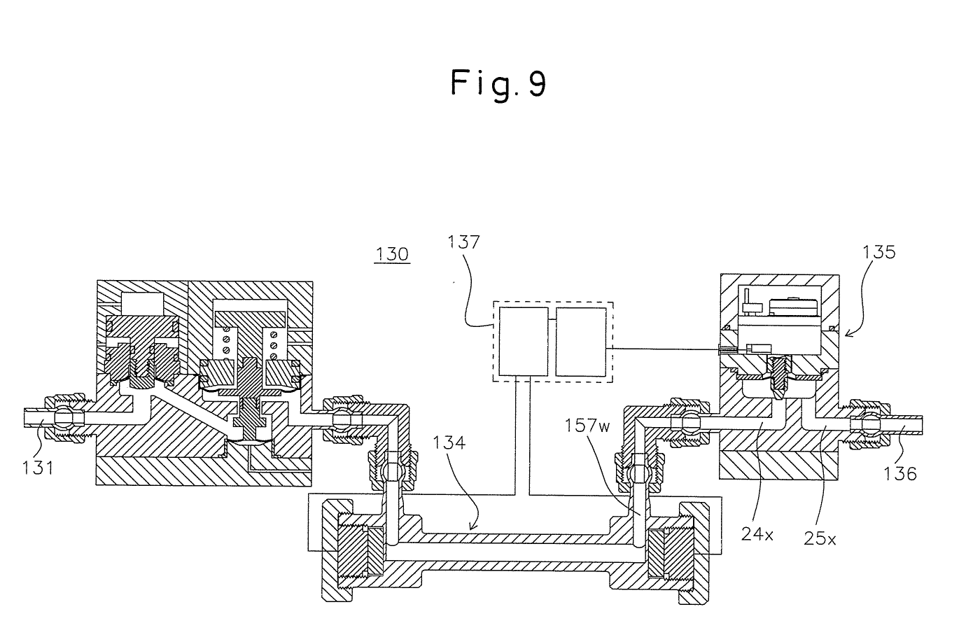

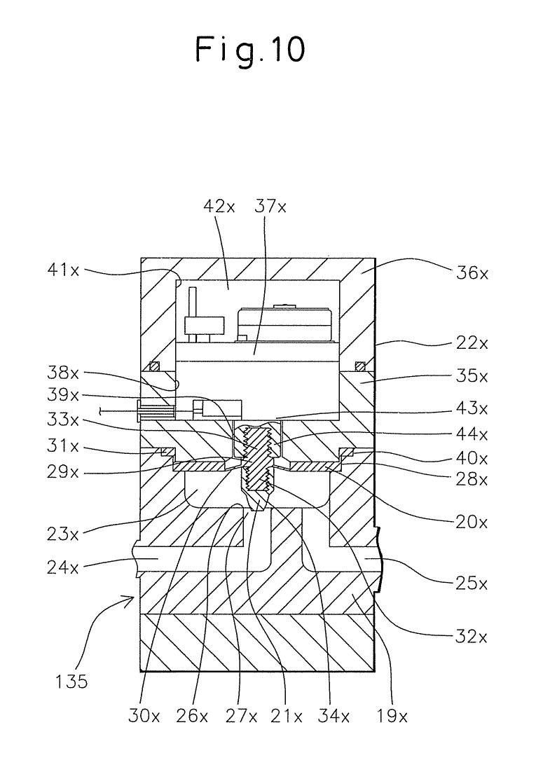

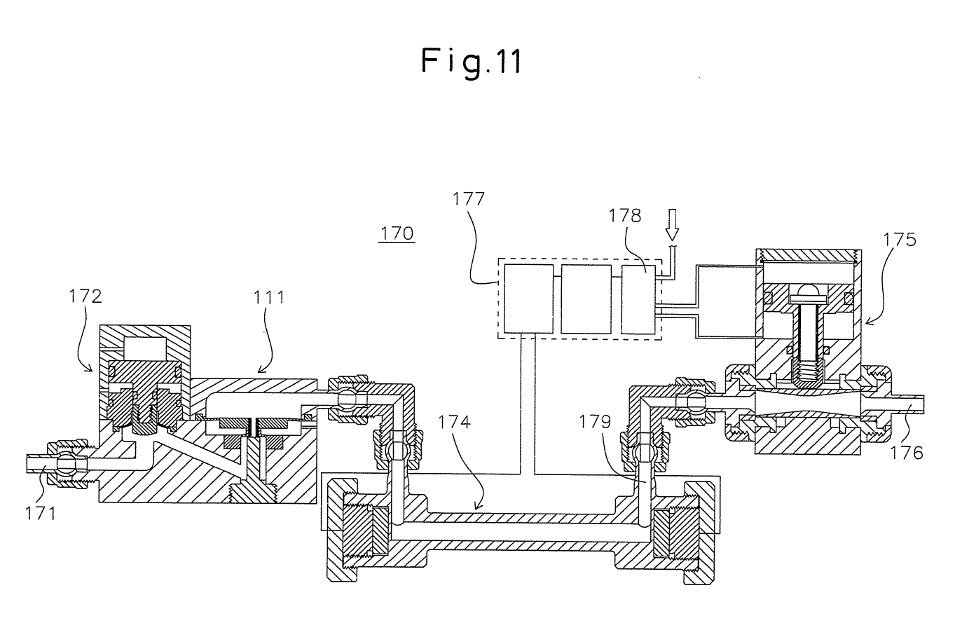

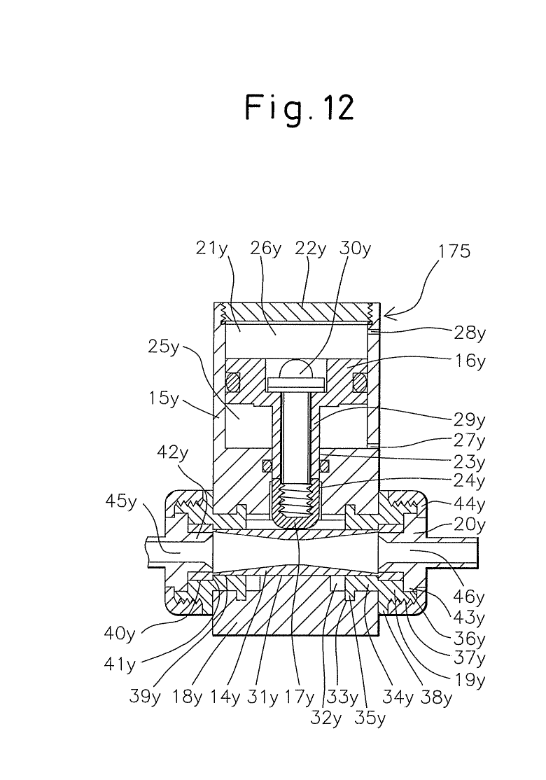

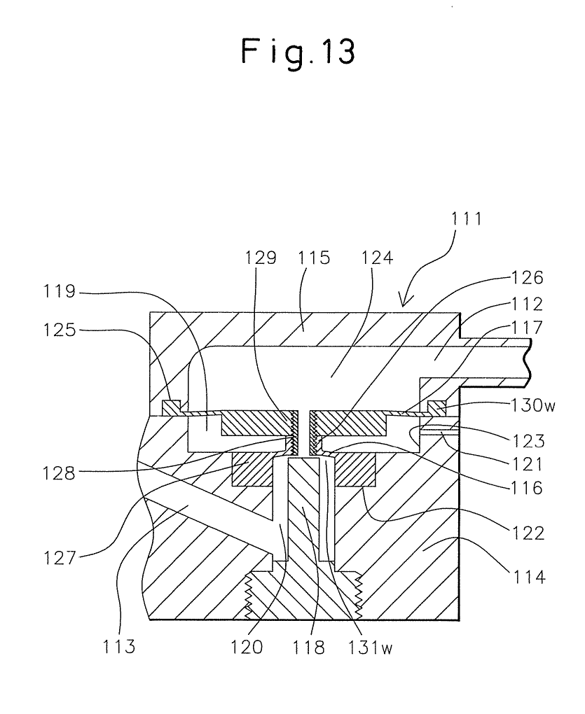

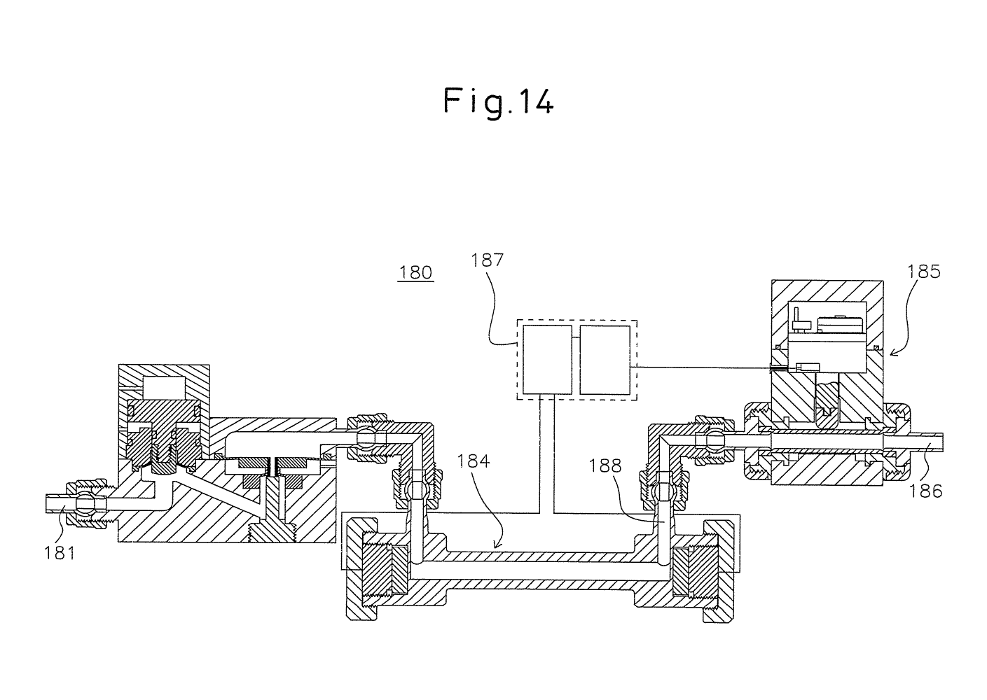

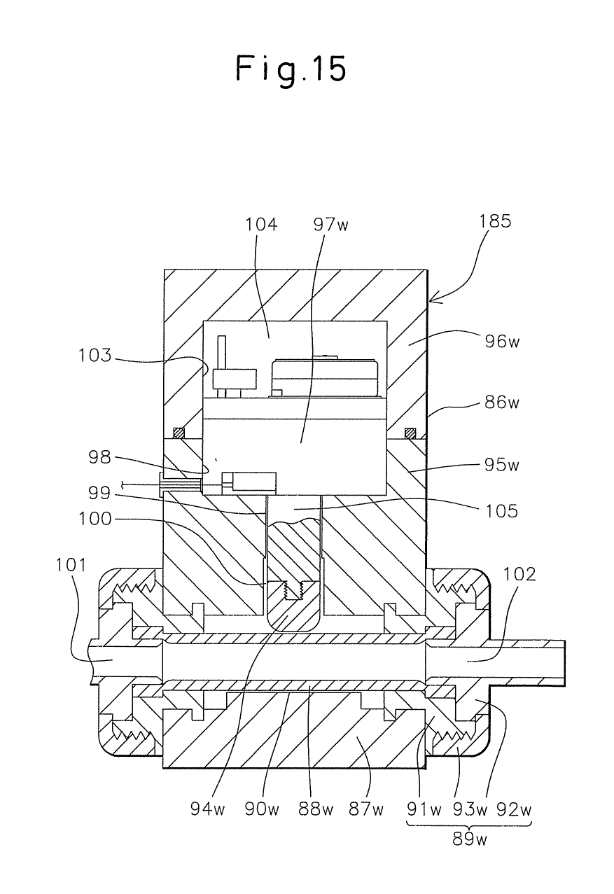

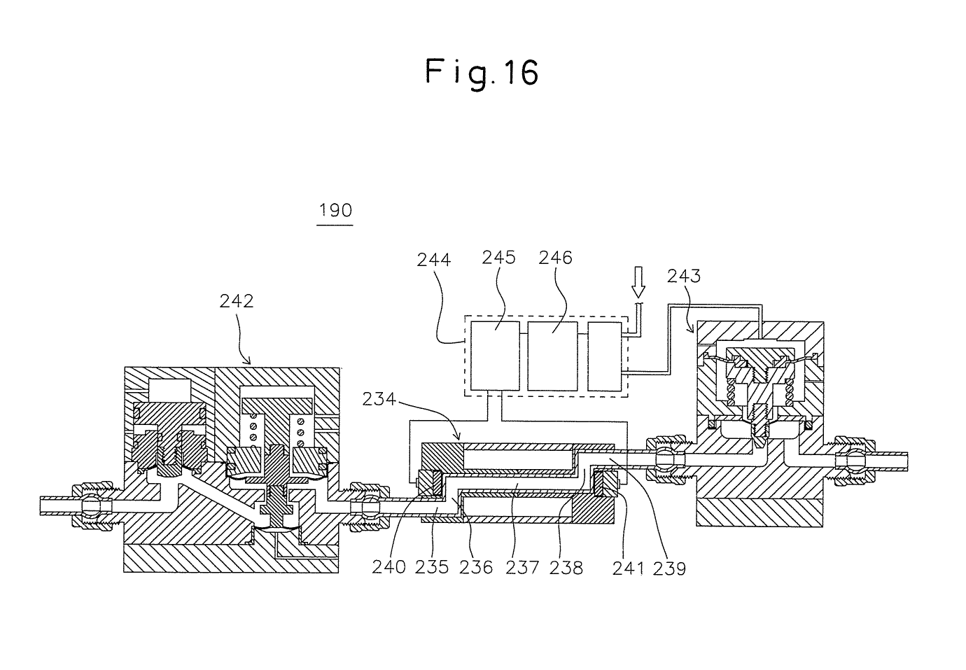

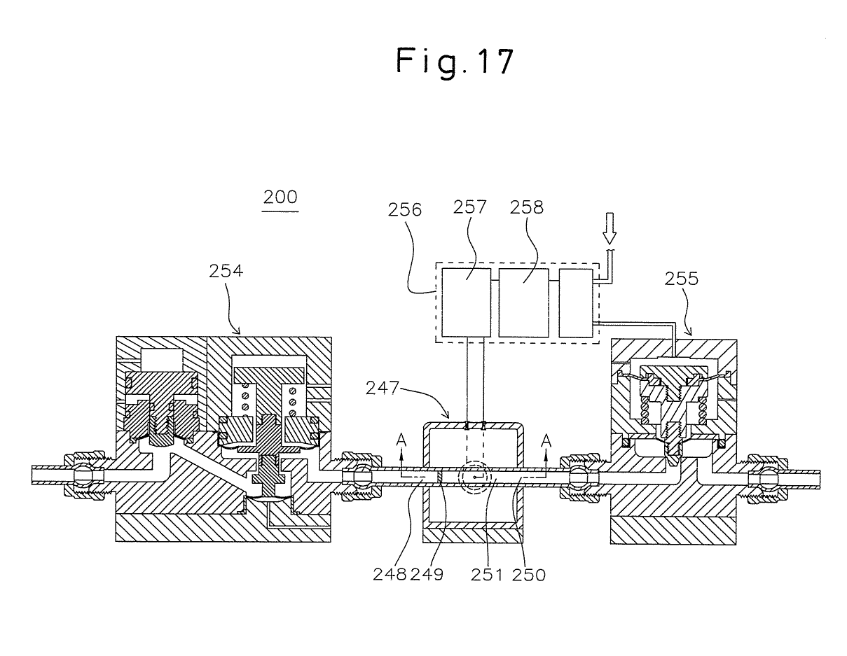

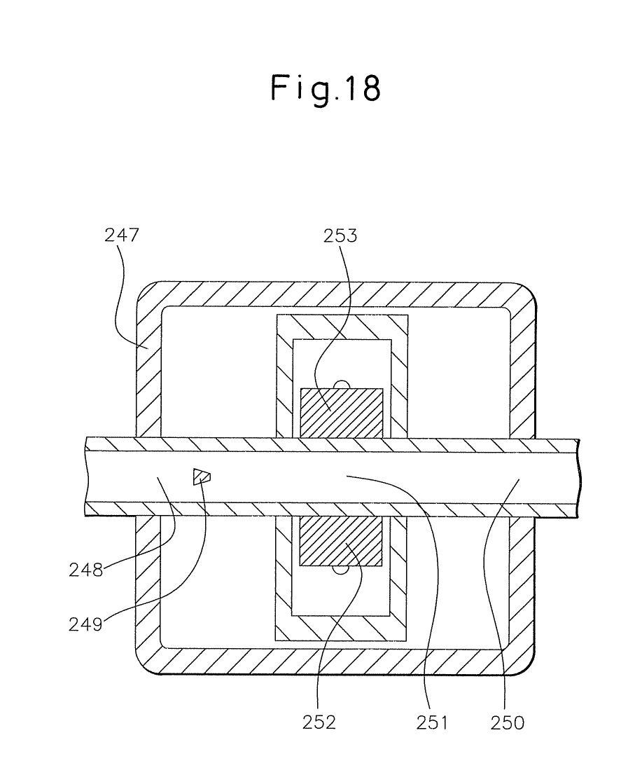

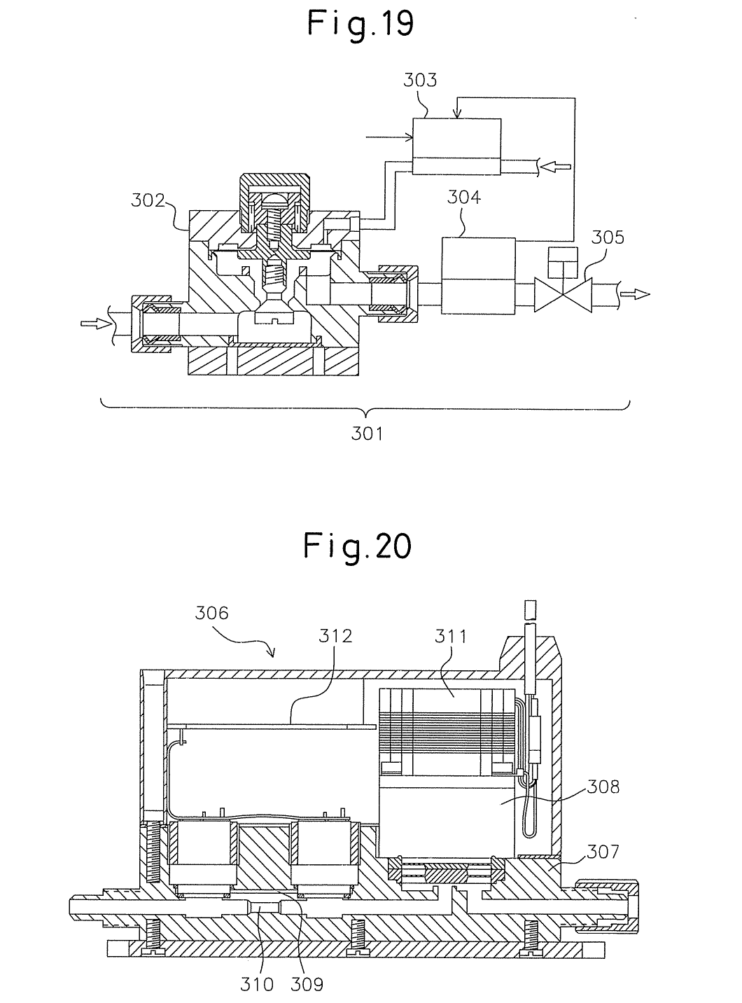

Below, the mode of carrying out the present invention will be explained with reference to the embodiments shown in the drawings, but the present invention is not limited to these embodiments of course. FIG. 1 is a vertical cross-sectional view of a fluid control system showing a first embodiment of the present invention. FIG. 2 is an enlarged view of a fluid control valve of FIG. 1. FIG. 3 is a vertical cross-sectional view of a fluid control system showing a second embodiment of the present invention. FIG. 4 is an enlarged view of a shutoff valve of FIG. 2. FIG. 5 is a vertical cross-sectional view of a fluid control system showing a third embodiment of the present invention. FIG. 6 is an enlarged view of a fluid adjustment valve of FIG. 5. FIG. 7 is a vertical cross-sectional view of a fluid control system showing a fourth embodiment of the present invention. FIG. 8 is a vertical cross-sectional view of a fluid control system showing a fifth embodiment of the present invention. FIG. 9 is a vertical cross-sectional view of a fluid control system showing a sixth embodiment of the present invention. FIG. 10 is an enlarged view of a fluid control valve of FIG. 9. FIG. 11 is a vertical cross-sectional view of a fluid control system showing a seventh embodiment of the present invention. FIG. 12 is an enlarged view of a fluid control valve of FIG. 11. FIG. 13 is an enlarged view of a pressure adjustment valve of FIG. 11. FIG. 14 is a vertical cross-sectional view of a fluid control system showing an eighth embodiment of the present invention. FIG. 15 is an enlarged view of a fluid control valve of FIG. 14. FIG. 16 is a vertical cross-sectional view of a fluid control system showing a ninth embodiment of the present invention. FIG. 17 is a vertical cross-sectional view of a fluid control system showing a 10th embodiment of the present invention. FIG. 18 is a cross-sectional view along the line A-A of FIG. 17.

### First Embodiment

Below, a fluid control system of a first embodiment of the present invention will be explained with reference to FIG. 1 and FIG. 2.

1 is a fluid control system installed in a semiconductor production facility performing an etching process in the production of semiconductors. The fluid control system 1 is formed from a fluid inflow port 2, flow rate measuring device 3, fluid control valve 4, fluid outflow port 5, and control part 6. These are configured as follows:

2 is a PFA fluid inflow port. The fluid inflow port 2 is communicated with an inlet passage 7 of the later-mentioned flow rate measuring device 3.

3 is a flow rate measuring device for measuring the flow rate of a fluid. The flow rate measuring device 3 has an inlet passage 7, a straight passage 8 provided vertical from the inlet passage 7, and an outlet passage 9 provided vertical from the straight passage 8 and provided in parallel to the inlet passage 7 in the same direction. Ultrasonic oscillators 10 and 11 are arranged facing each other at positions where the side walls of the inlet and outlet passages 7 and 9 intersect the axis of the straight passage 8. The outlet passage 9 is communicated with the inlet passage 24 of the later explained fluid control valve 4. The ultrasonic oscillators 10 and 11 are covered by a fluororesin, while the wires extending from said oscillators 10 and 11 are connected to a later explained processor 54 of the control part 6. Note that everything other than the ultrasonic oscillators 10 and 11 of the flow rate measuring device 3 are made of PFA. Further, the inlet passage 7 and the fluid inflow port 2 are directly connected through a connection member 57 changed in direction in the passage, while the outlet passage 9 and the inlet passage 22 of the later mentioned fluid control valve 4 are directly connected and communicated through a connection member 58 changed in direction in the passage.

As shown in FIG. 2, 4 is a fluid control valve controlling the flow rate of the fluid by changing the opening area of the passage (air type needle valve). The fluid control valve 4 is formed from a main body 14, cylinder 15, bonnet 16, first diaphragm 17, valve element 18, second diaphragm 19, rod 20, diaphragm holder 21, and spring 22.

14 is a polytetrafluoroethylene (hereinafter referred to as “PTFE”) main body. At the top part is provided a cylindrical valve chamber 23. Communicating with this valve chamber 23, an inlet passage 24 and outlet passage 25 are provided at the bottom. At the center of the bottom part of the valve chamber, an opening part 26 connected to the outlet passage 25 is provided, while at the peripheral side of the opening part 26, an opening part 27 connected with the inlet passage 24 is provided. The opening part 27 is circular in horizontal cross-sectional shape, but when enlarging the opening part 26 for controlling the flow rate over a broader range, it is preferably formed into a substantially crescent shape at the peripheral part centered about the opening part 26 provided at the center of the bottom part of the valve chamber. At the top surface of the main body 14, a ring-shaped groove 43 with which the seal part of the first diaphragm 17 is engaged in provided.

15 is a polyvinyl chloride (hereinafter called “PVC”) cylinder. This has a through hole 28 at the center of the bottom part and a step part 48 at the inside surface of the bottom part and is provided with a breathing hole 29 at the side surface. The cylinder 15 clamps and fastens the main body 1 and the peripheral edge of the first diaphragm 17 and clamps and fastens the bonnet 16 and the peripheral edge of the second diaphragm 19. The breathing hole 29 provided at the side surface of the cylinder 15 is provided so as to exhaust the gas when a fluid becomes a gas and passes through the first diaphragm 17.

16 is a PVC bonnet. This is provided at its top part with a working fluid communicating port 30 introducing compressed air and a exhaust port 31. In the present embodiment, the working fluid communicating port 30 is provided at the top part of the bonnet 16, but it may also be provided at the side surface. Note that the exhaust port 31 need not be provided if there is no need for it in the supply of compressed air. Further, at the bottom part of the peripheral side part, a ring-shaped groove 44 to which the seal part 40 of the second diaphragm 19 is engaged is provided. The above explained main body 14, cylinder 15, and bonnet 16 are fastened together by bolts and nuts (not shown).

17 is a PTFE first diaphragm. A mounting part 33 fastened by engagement with the rod 20 is provided at a top position of the shoulder part 32 centered about the shoulder part 32. Further, a connecting part 45 to which the valve element 18 is fastened is provided integrally sticking out at the bottom position. Further, a thin film part 34 is provided at the part extending in the radial direction from the shoulder part 32, a thick part 35 is provided continuing from the thin film part 34, and a seal part 36 is provided at the peripheral edge of the thick part 35. These are formed integrally. The thickness of the thin film part 34 is made about 1/10th of the thickness of the thick part 35. The method of fastening the rod 20 and the mounting part 33 may be not only snap engagement, but also screwing or adhesion. The connecting part 45 and the valve element 18 are preferably fastened by screwing. The seal part 36 positioned at the outer peripheral edge of the first diaphragm 17 is formed into an L-shaped cross-section in the axial direction, is engaged with the ring-shaped groove 43 of the main body 14 through the O-ring 49, and is fastened by being clamped by being pushed against a ring-shaped projection 41 provided at the bottom part of the cylinder 15.

18 is a PTFE valve element. This is fastened by screwing to a connecting part 45 provided at the bottom part of the first diaphragm 19. The valve element 18 is not limited to the shape like in the present embodiment and may also be a spherical valve element or conical shaped valve element in accordance with the desired flow rate characteristics. Furthermore, a valve element with an outer circumferential rib is suitably used for full closure in a state greatly reducing the sliding resistance.

19 is an ethylene propylene diene copolymer (hereinafter referred to as “EPDM”) second diaphragm. It has a center hole 37, a surrounding thick part 38, a ring-shaped projection 41 at the top part of the thick part, a thin film part 39 extending in the radial direction from the thick part 38, and a seal part 40 provided at the peripheral edge of the thin film part 39 —all formed integrally. At a shoulder part 42 positioned at the top part of the rod 19 at the bottom part of which a mounting part 33 of the first diaphragm 17 is fastened, this is clamped and fastened by a diaphragm holder 21 through the center hole 37. In this embodiment, EPDM is used as the material, but a fluorine-based rubber or PTFE is also possible.

20 is a PVC rod. This is provided at its top part with a shoulder part 42 enlarged in diameter. At the center of the shoulder part 42, a connecting part 47 of a diaphragm holder 21 is screwed whereby the second diaphragm 19 is gripped and fastened. At the lower part, it is arranged in a loosely engaged state in a through hole 28 at the bottom part of the cylinder 15. At the bottom end, a mounting part 33 of the first diaphragm 17 is fastened. Further, a spring 22 is fit between the bottom surface of the shoulder part 42 of the rod 20 and the step part 20 of the cylinder 15.

21 is a PVC diaphragm holder. At the center of the bottom surface, a connecting part 47 connected by screwing with the rod 20 is provided. Further, at the bottom surface, a ring-shaped groove 46 engaged with the ring-shaped projection 41 of the second diaphragm 19 is provided.

22 is an SUS spring. This is engaged and supported in a state preventing movement in the radial direction between the bottom surface of the shoulder part 42 of the rod 20 and the step part 48 of the cylinder 15. Further, the bottom surface of the shoulder part 42 is constantly biased upward. The entire surface of the spring 22 is covered by a fluororesin. Further, the spring 22 can be suitably used while changing the spring constant according to the caliber or range of pressure used of the fluid control valve. A plurality may also be used.

Returning to FIG. 1, 5 is a PFA fluid outflow port. 6 is a control unit. The control unit 6 has a processor 54 for calculating the flow rate from a signal output from the flow rate measuring device 3 and a control part 55 performing feedback control. The processor 54 is provided with a transmission circuit outputting a fixed period ultrasonic vibration to the transmitting side ultrasonic oscillator 10,

a reception circuit receiving ultrasonic vibration from the receiving side ultrasonic oscillator 11, a comparison circuit comparing the propagation times of the ultrasonic vibrations, and a processing circuit calculating the flow rate from the difference in propagation times output from the comparison circuit. The control unit 55 has a control circuit controlling the later mentioned electropneumatic converter 56 and operating the pressure of the control air so that the flow rate output from the processor 54 becomes the set flow rate. Note that in this embodiment, the control unit 6 is comprised provided separate from the fluid control system 1 so as to enable central control at a separate location, but it may also be provided integrally with the fluid control system 1.

56 is an electropneumatic converter for adjusting the operating pressure of compressed air. The electropneumatic converter 56 is comprised from a solenoid valve electrically driven for proportionally adjusting the operating voltage. It adjusts the operating pressure of the air for controlling the fluid control valve 4 in accordance with a control signal from said control unit 6.

Next, the operation of the fluid control system of the first embodiment of the present invention will be explained.

The fluid flowing into the fluid inflow port 2 of the fluid control system 1 first flows into the flow rate measuring device 3 where it is measured for the flow rate in the straight passage 8. The ultrasonic vibration is propagated from the ultrasonic oscillator 10 positioned at the upstream side with respect to the flow of fluid toward the ultrasonic oscillator 11 positioned at the downstream side. The ultrasonic vibration received by the ultrasonic oscillator 11 is converted to an electrical signal and output to the processor 54 of the control unit 6. When the ultrasonic vibration is propagated from the upstream side ultrasonic oscillator 10 to the downstream side ultrasonic oscillator 11 and received, transmission and reception are instantaneously switched in the processor 54 and ultrasonic vibration is propagated from the ultrasonic oscillator 11 positioned at the downward stream toward the ultrasonic oscillator 10 positioned at the upstream side. The ultrasonic vibration received by the ultrasonic oscillator 10 is converted to an electrical signal and output to the processor 54 in the control unit 6. At this time, the ultrasonic vibration is propagated against the flow of the fluid in the straight passage 8, so compared with when propagating the ultrasonic vibration from the upstream side to the downstream side, the speed of propagation of the ultrasonic vibration in the fluid is slow and the propagation time becomes longer. The mutual electric signals output are used in the processor 54 for measurement of the propagation times. The flow rate is calculated from the difference in propagation times. The flow rate calculated by the processor 54 is converted to an electrical signal which is output to the control unit 55.

Next, the fluid passing through the flow rate measuring device 3 flows into the fluid control valve 4. The control unit 55 outputs a signal to the electropneumatic converter 56 so as to make the difference between any set flow rate and the flow rate measured in real time zero. The electropneumatic converter 56 supplies control air having the corresponding operating pressure to the fluid control valve 4 to drive it. The fluid flowing out from the fluid control valve 4 is controlled by the fluid control valve 4 so that the flow rate becomes a set flow rate, that is, the difference between the set flow rate and the measured flow rate is converged to zero.

Here, the operation of the fluid control valve 4 with respect to the operating pressure supplied from the electropneumatic converter 56 will be explained with reference to FIG. 2.

The fluid control valve 4 gives the maximum flow rate of the fluid in the state where the compressed air supplied from the working fluid communicating port 30 provided at the top part of the bonnet 16 is zero, that is, in the closed state. At this time, the valve element 18 stops at the position where the biasing force of the spring 22 fit between the step part 48 of the cylinder 15 and the bottom surface of the shoulder part 42 of the rod 20 causes the top part of the diaphragm holder 21 connected to the top part of the rod 20 to contact the bottom surface of the bonnet 15.

In this state, if raising the pressure of the compressed air supplied from the working fluid communicating port 30, the inside of the bonnet 16 is sealed tight by the thin film part 39 of the second diaphragm 19 with the seal part 40 engaged with the bonnet 16 and by the bonnet 16, so the compressed air pushes the diaphragm holder 21 and the second diaphragm 19 downward and the valve element 18 is inserted in the opening part 26 through the rod 20 and the first diaphragm 17. Here, if making the pressure of the compressed air supplied from the working fluid communicating port 30 constant, the valve element 18 stops at the position where the biasing force of the spring 22 and the pressures received by the bottom surface of the thin film part 34 of the first diaphragm 17 and the bottom surface of the valve element 18 from the fluid balance out. Therefore, the opening part 26 is reduced in opening area due to the inserted valve element 18, so the flow rate of the fluid is also reduced.

Furthermore, if raising the pressure of the compressed air supplied from the working fluid communicating port 30, the valve element 18 is further pushed down and finally the opening part 26 is contacted and the fully closed state is reached (state of FIG. 2).

Further, if exhausting the compressed air, the inside of the bonnet 16 sealed tight by the thin film part 39 of the second diaphragm 19 with the seal part 40 engaged with the bonnet 16 and by the bonnet 16 falls in pressure, the biasing force of the spring 22 becomes larger and the rod 20 is pushed down. The rod rises, whereby the valve element 18 fastened to it through the first diaphragm 17 also rises and the fluid control valve becomes open.

Due to the above operation, the fluid flowing into the fluid inflow port 2 of the fluid control system 1 is controlled to be constant by a set flow rate and flows out from the fluid outflow port 5. Further, the fluid control valve 4 is compact and enables stable fluid pressure control due to the above configuration.

Due to the above operation, the fluid flowing into the fluid control system 1 is controlled to a set flow rate by feedback control by the flow rate measuring device 3, fluid control valve 4, and control unit 6. The ultrasonic flow rate meter constituting the flow rate measuring device 3 measures the flow rate from the difference in propagation time with respect to the direction of flow of the fluid, so can accurately measure even a fine flow rate. Further, the fluid control valve 4 is compact and enables stable fluid pressure control due to the above configuration, so exhibits a superior effect in fluid control by a fine flow rate.

### Second Embodiment

Next, a fluid control system of a second embodiment of the present invention will be explained with reference to FIG. 3 and FIG. 4.

As shown in FIG. 3, a fluid control system 59 is formed from a fluid inflow port 60, shutoff valve 61, flow rate measuring device 62, fluid control valve 63, fluid outflow port 64, and control part 65. These parts are configured as follows:

As shown in FIG. 4, the shutoff valve 61 is formed from a main body 66, a drive unit 67, a piston 68, a diaphragm holder 69, and a valve element 70.

66 is a PTFE main body. It has a valve chamber 71 at the center of the top end in the axial direction and an inlet passage 72 and outlet passage 73 communicating with the valve chamber 71. The inlet passage 72 communicates with the fluid inflow port 60, while the outlet passage 73 communicates with the flow rate measuring device 62. Further, at the outer side of the valve chamber 71 at the top face of the main body 66, a ring-shaped groove 74 is provided.

67 is a PVDF drive part. This is provided inside it with a cylindrical cylinder part 75 and is fastened to the top of said main body 66 by bolts and nuts (not shown). At the side face of the drive part 67, a pair of operating fluid feed ports 76 and 77 communicated with the top side and bottom side of the cylinder part 75 are provided.

68 is a PVDF piston. This is inserted into the cylinder part 75 of the drive part 67 in a sealed state and able to move vertically in the axial direction and is provided at the center of its bottom face with a rod part 78 vertically down.

69 is a PVDF diaphragm holder. It has a through hole 79 through which the rod part 78 of the piston 68 passes at its center part and is gripped between the main body 66 and the drive part 67.

70 is a PTFE valve element housed in a valve chamber 71. It passes through the through hole 79 of the diaphragm holder 69, is screwed with the front end of the rod part 78 of the piston 68 sticking out from the bottom face of the diaphragm holder 69, and moves up and down in the axial direction along with vertical motion of the piston 68. The valve element 70 has a diaphragm 80 at its outer circumference. The outer circumferential edge of the diaphragm 80 is inserted into the ring-shaped groove 74 of the main body 66 and is clamped between the diaphragm holder 69 and the main body 66. The rest of the configuration of the second embodiment is similar to that of the first embodiment, so the explanation will be omitted.

Next, the operation of the fluid control system of the second embodiment of the present invention will be explained.

The fluid flowing into the fluid inflow port 60 of the fluid control system 59 first flows into the shutoff valve 61. When the shutoff valve 61 is closed, the fluid is cut off by the shutoff valve 61 and the fluid no longer flows downstream from the shutoff valve 61. Due to this, the flow rate measuring device 62, fluid control valve 63, and control part 64 in the fluid control system 59 can be easily maintained etc. Further, when some sort of trouble occurs in the passage, the shutoff valve 61 can be closed to cut off the fluid on an emergency basis, so it is possible to prevent secondary damage such as corrosive fluid leaking out and corroding the parts in the semiconductor production facility. Further, when the shutoff valve 61 is opened, the fluid passes through the shutoff valve 61, flows into the flow rate measuring device 62, is controlled by the flow rate measuring device 62, fluid control valve 63, and control part 65 by feedback control so as to become a set flow rate, and flows out from the fluid outflow port 64.

Here, the operation of the shutoff valve 61 will be explained. If compressed air is injected from the outside from a working fluid feed port 77 as a working fluid, the pressure of the compressed air pushes up a piston 68, so the rod 78 connected to this is lifted upward, the valve element 70 connected to the bottom end of the rod 78 is also lifted upward, and the valve opens.

On the other hand, if compressed air is injected from the working fluid feed port 76, the piston 68 is pushed down. Along with this, the rod 78 and the valve element 70 connected to its bottom end are also pushed downward and the valve closes.

Due to the above operation, the fluid flowing into the fluid inflow port 60 of the fluid control system 59 is cut off by closing the shutoff valve 61, whereby the maintenance etc. of the fluid control system 59 can be easily performed and the fluid can be cut off on an emergency basis. The rest of the operation of the second embodiment is similar to that of the first embodiment, so an explanation will be omitted.

### Third Embodiment

Next, a fluid control system of a third embodiment of the present invention will be explained with reference to FIG. 5 and FIG. 6.

As shown in FIG. 5, a fluid control system 81 is formed from a fluid inflow port 82, pressure adjustment valve 83, flow rate measuring device 84, fluid control valve 85, fluid outflow port 86, and control part 87. These are configured as follows:

As shown in FIG. 6, 83 is a pressure adjustment valve for reducing pressure fluctuations of a fluid.

The pressure adjustment valve 83 is formed from a main body 12w, bonnet 13w, spring holder 14w, piston 15w, spring 16w, first valve mechanism 17w, second valve mechanism 18w, and baseplate 19w.

12w is a PTFE main body. This has a second cavity 20w provided at a center of a bottom part and opening at a base part and a first cavity 21w provided at a top part with a top face open and having a diameter larger than a diameter of the second cavity 20w. It is provided at its side face with an inlet passage 22w communicating with the second cavity 20w, at the face facing the inlet passage 22w with an outlet passage 23w communicating with the first cavity 21w, and further a communicating hole 24w communicating the first cavity 21w and second cavity 20w and having a diameter smaller than the diameter of the first cavity 21w. The top face part of the second cavity 20w is made a valve seat 25w. Further, the outlet passage 23w is communicated with the flow rate measuring device 84.

13w is a PVDF bonnet. This is provided inside it with a cylindrical space 26w and with a step part 27w enlarged in diameter over the space 26w at the inner circumference of a bottom end and is provided at its side face with an air feed hole 28w communicating the space 26w and the outside for supplying the inside of the space 26w with compressed air and a fine exhaust hole 29w for exhausting fine amounts of compressed air introduced from the air feed hole 28w. Note that the exhaust hole 29w need not be provided when not required for the supply of compressed air.

14w is a PVDF flat circular shaped spring retainer. It has a through hole 30w at its center. The approximate top half is inserted into the step part 27w of the bonnet 13w. At the side face of the spring retainer 14w, a ring-shaped groove 31w is provided. By fitting an O-ring 32w into it, outflow of compressed air from the bonnet 13w to the outside is prevented.

15w is a PVDF piston. This has at its top part a disk-shaped flange 33w, a piston shaft 34w provided sticking out from the bottom part of the center of the flange 33w in a columnar shape, and a first connecting part 35w comprised of a female thread part provided at the bottom end of the piston shaft 34w. The piston shaft 34w is provided in a smaller diameter than the through hole 30w of the spring retainer 14w, while the first connecting part 35w is connected with a second connecting part 40w of the later explained first valve mechanism 17w by screwing.

16w is a SUS spring. This is gripped between the bottom end face of the flange 33w of the piston 15w and the top end face of the spring retainer 14w. Along with vertical motion of the piston 15w, the spring 16w also expands and contracts. So that the change in load at that time becomes small, one with a long free length is preferably used.

17w is a PTFE first valve mechanism. This has a first diaphragm 38w having a film part 37w having a tubular part 36w provided sticking out upward from its outer peripheral edge and having a thick part at its center, a second connecting part 40w comprised of a small diameter male thread provided at a top end of a shaft 39w provided sticking out from the top face of the center of the first diaphragm 38w, and a third connecting part 41w provided sticking out from the bottom face of the center, comprised of a female thread part formed at the bottom end, and screwed with a fourth connecting part 45w of the later explained second valve mechanism 18w. The tubular part 36w of the first diaphragm 38w is fastened by being gripped between the main body 12w and the spring retainer 14w, so the first valve chamber 42w formed by the bottom face of the first diaphragm 38w is formed sealed tight. Further, the top face of the first diaphragm 38w and the space 26w of the bonnet 13w are sealed tight through the O-ring 32w and form an air chamber filled with compressed air supplied from the air feed hole 28w of the bonnet 13w.

18w is a PTFE second valve mechanism. It is configured from a valve element 43w arranged inside the second cavity 20w of the main body 12w and provided in a larger diameter than the communicating hole 24w, a shaft 44w provided sticking out from the top end face of the valve element 43w, a fourth connecting part 45w provided at its top end and comprised of a male thread part fastened by connection by screwing with the third connecting part 41w, a rod 46w provided sticking out from the bottom end face of the valve element 43w, and a second diaphragm 48w provided extending from the bottom end face of the rod 46w in the radial direction and having a tubular projection 47w provided sticking out downward from its peripheral edge. The tubular projection 47w of the second diaphragm 48w is gripped between a projection 50w of the later explained baseplate 19w and the main body 12w, whereby a second valve chamber 49w formed between the second cavity 20w of the main body 12w and the second diaphragm 48w is sealed tight.

19w is a PVDF baseplate. This has a projection 50w fastening the tubular projection 47w of the second diaphragm 48w of the second valve mechanism 18w by gripping it with the main body 12w at the center of its top part, is provided with a cut recess 51w at the top end of the projection 50w, and is provided with a breathing hole 52w communicating with the cut recess 51w at its side face. It is fastened gripping the main body 12w with the bonnet 13w by bolts and nuts (not shown). Note that in this embodiment, the spring 16w is configured provided inside the space 26w of the bonnet 13w to bias the piston 15w, first valve mechanism 17w, and second valve mechanism 18w upward, but the spring 16w may also be configured provided in the cut recess 51w of the baseplate 19w to bias the piston 15w, first valve mechanism 17w, and second valve mechanism 18w upward. The rest of the configuration of the third embodiment is similar to that of the first embodiment, so the explanation will be omitted.

Here, the operation of the pressure adjustment valve 83 with respect to the operating pressure supplied from the electropneumatic converter (not shown) will be explained (see FIG. 6).

The valve element 43w of the second valve mechanism 18w is acted on by a force biasing it upward due to the springback force of the spring 16w gripped between the flange part 33w of the piston 15w and the spring retainer 14w and the fluid pressure at the bottom surface of the first diaphragm 38w of the first valve mechanism 17w and acted on by a force biasing it downward due to the operating pressure at the top surface of the first diaphragm 38w. Furthermore, strictly speaking, the bottom surface of the valve element 43w and the top surface of the second diaphragm 48w of the second valve mechanism 18w receive the fluid pressure, but their pressure receiving areas are made substantially equal, so the forces are substantially cancelled out. Therefore, the valve element 43w of the second valve mechanism 18w stops at the position where the above three forces balance out.

If increasing the operating pressure supplied from the electropneumatic converter, the force pushing down the first diaphragm 38w increases, whereby the opening area of the fluid control unit 53w formed between the valve element 43w and valve seat 25w of the second valve mechanism 18w increases, so the pressure of the first valve chamber 42w can be increased. Conversely, if reducing the operating pressure, the opening area of the fluid control unit 53w is reduced and the pressure is also reduced. For this reason, by adjusting the operating pressure, it is possible to set any pressure.

In this state, when the upstream side fluid pressure increases, instantaneously the pressure inside the first valve chamber 42w also increases. This being the case, compared with the force received by the top surface of the first diaphragm 38w from the compressed air due to the operating pressure, the force received by the bottom surface of the first diaphragm 38w from the fluid becomes larger and the first diaphragm 38w moves upward. Along with this, the position of the valve element 43w also moves upward, so the opening area of the fluid control unit 53w formed with the valve seat 25w is reduced and the pressure in the first valve chamber 42w is reduced. Finally, the position of the valve element 43w moves and stops at the position where the above three forces balance out. At this time, if the load of the spring 16w does not greatly change, the pressure inside the space 26w, that is, the pressure received by the top surface of the first diaphragm 38w, is constant, so the pressure received by the bottom surface of the first diaphragm 38w becomes substantially constant. Therefore, the fluid pressure of the bottom surface of the first diaphragm 38w, that is, the pressure inside the first valve chamber 42w, becomes substantially the same as the original pressure before the upstream side pressure increased.

When the upstream side fluid pressure is reduced, instantaneously the pressure in the first valve chamber 42w also decreases. This being so, compared with the force received by the top surface of the first diaphragm 38w from the compressed air due to the operating pressure, the force received by the bottom surface of the first diaphragm 38w from the fluid becomes smaller and the first diaphragm 38w moves downward. Along with this, the position of the valve element 43w also moves downward, so the opening area of the fluid control unit 53w formed with the valve seat 25w increases and makes the fluid pressure of the first valve chamber 42w. Finally, the position of the valve element 43w moves and stops at the position where the above three forces balance out. Therefore, in the same way as the case where the upstream side pressure increases, the fluid pressure in the first valve chamber 42w becomes substantially the original pressure.

Next, the operation of the fluid control system 81 according to the third embodiment of the present invention will be explained.

The fluid flowing into the fluid control system 81 is controlled to the set flow rate by feedback control by the flow rate measuring device 84, fluid control valve 85, and control unit 87. The ultrasonic flow rate meter constituting the flow rate measuring device 84 can accurately measure even a fine flow rate since it measures the flow rate from the difference in propagation times with respect to the flow direction of the fluid. Further, the fluid control valve 85 is compact and enables stable control of the flow rate due to the above configuration, so exhibits superior effect in fluid control by a fine flow rate. Further, even if the upstream side pressure of the fluid flowing into the fluid control system 81 pulsates, the pulsation is attenuated by the operation of the pressure adjustment valve 83, so it is possible to stably and precisely measure and control the flow rate even if instantaneous pressure fluctuations such as pump pulsation occur.

Due to the above, the fluid flowing into the fluid inflow port 82 of the fluid control system 81 can be stably and precisely controlled by feedback control by the pressure adjustment valve 83, flow rate measuring device 84, and fluid control valve 85.

### Fourth Embodiment

Next, a fluid control system according to a fourth embodiment of the present invention will be explained with reference to FIG. 7.

90 is a fluid control system. The fluid control system 90 is formed from a fluid inflow port 91, shutoff valve 92, pressure adjustment valve 93, flow rate measuring device 94, fluid control valve 95, fluid outflow port 96, and control unit 97. The constitutions and operations of the fourth embodiment are similar to those of the first embodiment to third embodiment, so their explanations will be omitted. In the fourth embodiment, feedback control is performed, the pressure adjustment valve 93 enables the flow rate to be controlled without problem even if pulsating fluid flows, the shutoff valve 92 enables easy maintenance of the fluid control system 90 etc., and the fluid can be cut off on an emergency basis.

Here, in the first embodiment to the fourth embodiment, the valves and the flow rate measuring device are directly connected without using any tubes or connecting pipes, so the fluid control system can be made compact and the space at the installation location can be reduced. Further, the installation work becomes easy and the work time can be shortened, and the passage in the fluid control system can be shortened to the minimum required length, so the fluid resistance can be suppressed.

### Fifth Embodiment

Next, a fluid control system of a fifth embodiment of the present invention will be explained with reference to FIG. 8.

138 is a fluid control system. The fluid control system 138 is formed from a fluid inflow port 139, shutoff valve 140, pressure adjustment valve 141, flow rate measuring device 142, fluid control valve 143, fluid outflow port 144, control part 145, and base block 146. The configuration of these are as follows:

146 is a base block of the fluid control system 138. The base block 146 is comprised of the main bodies of the shutoff valve 140, pressure adjustment valve 141, flow rate measuring device 142, fluid control valve 143 formed into a single unit. As the main body of the shutoff valve 140, at the top part of the base block 146, a valve chamber 147 and an inlet passage 148 and outlet passage 149 communicated with the valve chamber 147 are formed. The inlet passage 148 is communicated with the fluid inflow port 139.

Further, the pressure adjustment valve 141 is arranged adjoining the shutoff valve 140. The outlet passage 149 of the shutoff valve 140 is communicated with the inlet passage 152 of the pressure adjustment valve 141.

The main body of the pressure adjustment valve 141 has a second cavity 150 provided at the bottom part of the base block 146 and opening at the bottom part and a first cavity 151 provided at the top part and opening at the top surface and having a diameter larger than the diameter of the second cavity 150. It is provided with an inlet passage 152 communicating with the second cavity 150, an outlet passage 153 communicating with the first cavity 151 in a direction facing the inlet passage 152, and a communicating port 154 communicating the first cavity 151 and second cavity 150 and having a diameter smaller than the diameter of the first cavity 151. The outlet passage 153 is communicated with the inlet passage 155 of the flow rate measuring device 142.

As the flow rate measuring device 142, there are an inlet passage 155, a straight passage 156 provided vertically from the inlet passage 155, and an outlet passage 157 provided vertically from the straight passage 156 and in parallel to the outlet passage 155 in the same direction. At positions where the side walls of the inlet and outlet passages 155 and 157 intersect the axis of the straight passage 156, ultrasonic oscillators 158 and 159 are arranged facing each other. The inlet passage 155 is communicated with the outlet passage 153 of the shutoff valve 141.

As the main body of the fluid control valve 143, there are a substantially dish shaped valve chamber 160 at the top part of the base block 146. At the center of the bottom part of the valve chamber 160, an opening part 162 communicating with the inlet passage 163 is formed, while in the valve 160, an opening 161 communicating with the output passage 164 is formed. Further, the inlet passage 163 is communicated with the outlet passage 159 of the fluid control valve 143, while the outlet passage 164 is communicated with the fluid outflow port 144. The rest of the configuration of the fifth embodiment is similar to that of the fourth embodiment except that the main body is formed as a single unit, so the explanation will be omitted.

The operation of the fluid control system of the fifth embodiment of the present invention is similar to the fourth embodiment, so the explanation will be omitted. In the fifth embodiment, feedback control is performed, the pressure adjustment valve 141 enables flow rate control without problem even if a pulsating fluid flows, the shutoff valve 140 enables maintenance etc. of the fluid control system 138 to be easily performed, and the fluid can be cut off on an emergency basis.

Here, the fifth embodiment is configured with the valves and flow rate measuring device of the fluid control system of the fourth embodiment arranged in a single base block formed with a passage, but the valves and flow rate measuring devices of the fluid control systems of the first embodiment to third embodiment may also be configured arranged in single base blocks formed with passages. Operations similar to the above embodiment are performed. At this time, since the fluid control system is arranged in a single base block formed with a passage, the fluid control system can be made compact and the space at the installation location can be reduced. Further, the installation work becomes easy and the work time can be shortened, and the passage in the fluid control system can be shortened to the minimum required length, so the fluid resistance can be suppressed. Furthermore, the number of parts can be reduced, so assembly of the fluid control system can be facilitated.

### Sixth Embodiment

Next, a fluid control system using another fluid control valve of a sixth embodiment of the present invention will be explained with reference to FIG. 9 to FIG. 10.

135 is a fluid control valve controlled in valve opening area by the later mentioned electrical drive part 22x. The fluid control valve 135 is formed by a main body 19x, diaphragm 20x, valve element 21x, and electrical drive part 22x.

19x is a PTFE main body. At the top part, a substantially dish-shaped valve chamber 23x is provided. An inlet passage 24x and outlet passage 25x are provided so as to communicate with the valve chamber 23x. At the bottom surface of the valve chamber 23x, a valve seat 26x is formed for shutting the passage by press-contact of the later mentioned valve element 21x. At the center of the bottom part, the later mentioned valve element 21x moves up and down, whereby an opening part 27x controlling the flow rate is formed. The inlet passage 24x is communicated with an outlet passage 157w of said flow rate measuring device 134, while the outlet passage 25x is communicated with the fluid outflow port 136. Further, the top surface of the main body 19x is provided with a ring-shaped recessed part 28x with which the ring-shaped seal part 31x of the later mentioned diaphragm 20x is engaged.

20x is a PTFE diaphragm. This is provided with a thick part 29x provided in a flange shape at the center, a disk shaped thin film part 30x provided extending out in the radial direction from the outer circumference of the thick part 29x, and a ring-shaped seal part 31x with an L-shaped cross-section in the axial direction at the outer circumferential edge of the thin film part 30x. The ring-shaped seal part 31x is engaged with the ring-shaped recessed part 28x of said main body 19x. At the bottom of the thick part 29x, a connecting part 32x screwed with the later mentioned valve element 21x is provided. At the top of the thick part 29x, a mounting part 33x screwed with the stem 43x connected to a shaft of the later mentioned motor part 37x is provided.

21x is a PTFE valve element. This is screwed into the connecting part 32x of said diaphragm 20x. Further, the valve element 21x is provided with a tapered part 34x reduced in diameter toward the bottom.

22x is an electrical drive part making the valve element 21x move up and down. The electrical drive part 22x is formed by a lower bonnet 35x and upper bonnet 36x and is provided with a motor part 37x and gears etc.

35x is a PVDF lower bonnet. It is provided with a recessed part 38x opening at its top and is provided with a through hole 39x at the center of the bottom part of the recessed part 38x. At the bottom surface of the lower bonnet 35x, an engagement part 40x with which a ring-shaped seal part 31x of the diaphragm 20x engages is provided. Said main body 19x and lower bonnet 35x grip and fasten said diaphragm 20x.

36x is a PVDF upper bonnet. This is provided with a recessed part 41x opened downward. The lower bonnet 35x and the upper bonnet 36x are connected whereby the two recessed parts 38x and 41x form a housing 42x. The later mentioned motor part 37x is set there.

37x is a motor part set in a housing part 42x. The motor part 37x has a stepping motor. At the bottom of the motor part 37x, a stem 43x connected to the shaft of the motor is provided. The stem 43x is positioned at the through hole 39x of said lower bonnet 35x. At the bottom of the stem 43x, a connecting part 44x to be screwed with a mounting part 33x of said diaphragm 20x is provided.

The main body 19x of the fluid control valve 135 and the lower bonnet 35x and upper bonnet 36x of the electrical drive part 22x are connected by bolts and nuts (not shown).

Next, the operation of the control system will be explained. The fluid passing through the flow rate measuring device 134 flows into the fluid control valve 135. The control unit 137 outputs a signal to the electrical drive part 22x so as to make the difference of the flow rate measured in real time from any set flow rate zero. The electrical drive part 22x drives the valve element 21x of the fluid control valve 135 in accordance with this. The fluid flowing out from the fluid control valve 135 is controlled by the fluid control valve 135 so that the flow rate becomes a set flow rate, that is, the difference between the set flow rate and the measured flow rate is converged to zero.

Here, the operation of the fluid control valve 135 due to transmission from the electrical drive part 22x will be explained. The fluid control valve 135 can adjust the flow rate of the fluid flowing through the fluid control valve 135 by having the motor part 37x of the electrical drive part 22x move the stem 43x up and down, whereupon the valve element 21x moves up and down through the stem 43x and the diaphragm 20x and the opening area is changed between the opening part 27x and the tapered part 34x of the valve element 21x inserted into the opening part 27x. Further, by operating the electrical drive part 22x to drive the valve element 21x in the downward direction and make the valve element 21x sit on the valve seat 26x, the valve element 21x can close the opening part 27x and cut off the fluid.

Due to the above operation, the fluid flowing into the fluid inflow port 131 of the fluid control system 130 is controlled to be constant by the set flow rate and flows out from the fluid outflow port 136. Further, the fluid control valve 135 is compact and enables stable control of the flow rate due to the above configuration, so exhibits superior effect in fluid control by a fine flow rate. The electrical drive part 22x has a motor part 37x for electrical drive. The motor part 37x enables easy fine control of the drive operation, so can stably control the flow rate with good response in accordance with a signal from the control unit 137. The rest of the configuration of the sixth embodiment is similar to that of the second embodiment, so the explanation will be omitted.

### Seventh Embodiment

Next, the operation of a fluid control system according to a seventh embodiment of the present invention will be explained with reference to FIG. 11 to FIG. 13.

As shown in FIG. 12, 175 is an air-type pinch valve controlling the flow rate in accordance with the operating pressure of the fluid control valve, that is, a fluid control valve. The fluid control valve 175 is formed by a pipe member 14y, cylinder main body 15y, piston 16y, compressor 17y, main body 18y, connecting member holders 19y, and connecting members 20y.

14y is a pipe member comprised of a composite of a fluororubber and silicone rubber through which a fluid flow. The pipe member 14y is for example formed to the desired thickness by stacking several layers of PTFE sheets impregnated by a silicone rubber. Note that in this embodiment, the pipe member 14y is made of a composite of a fluororesin and a silicone rubber, but may also be EPDM, silicone rubber, fluororubber, composites of the same, and other elastic members and is not particularly limited.

15y is a PVDF cylinder main body. The cylinder main body 15y has a cylinder part 21y having a cylindrical shaped space. At the top end, a disk shaped cylinder lid 22y is screwed in via an O-ring. At the center part of the bottom surface of the cylinder main body 15y, a through hole 23y through which a later explained connecting part 29y of the piston 16y passes and an elliptical slit 24y for housing the compressor 17y are continuously provided. Further, at the circumferential side surface of the cylinder main body 15y, air ports 27y and 28y are provided communicating the later mentioned electropneumatic converter 62y to a first space 25y formed by the inner circumferential surface and bottom surface of the cylinder part 21y and the bottom end surface of the later mentioned piston 16y and a second space 26y formed by the inner circumferential surface of the cylinder part 21y and the bottom end surface of the cylinder lid 22y and the top end surface of the later mentioned piston 16y.

16y is a PVDF piston. The piston 16y is disk-shaped with a O-ring attached to the circumferential side surface and is engaged in a sealed state to be able to move up and down at the inner circumferential surface of the cylinder part 21y. Further, it is provided with a connecting part 29y suspended down from the center of the piston 16y. This passes through a through hole 23y provided at the center part of the bottom surface of said cylinder main body 15y in a sealed state. A later mentioned compressor 17y is fastened to the front end part. Note that in this embodiment, the later mentioned compressor 17y is fastened by being screwed to the front end of a fastening bolt 30y provided passing through the connecting part 29y. Further, the method of fastening the compressor 17y may be to form the connecting part 29y into a rod shape and screw, adhere, or weld the compressor to the front end and is not particularly limited.

17y is a PVDF compressor. The cross-section of the part pushing the pipe member 14y is formed into a loaf shape. Further, the compressor 17y is fastened to the connecting part 29y of the piston 16y so as to perpendicularly intersect the passage axis. At the time of valve opening, it is housed in the elliptical slit 24y of the cylinder main body 15y.

18y is a PVDF main body fastened by connection to the bottom end surface of the cylinder main body 15y by bolts and nuts etc. (not shown). On the passage axis of the main body 18y, a rectangular cross-section groove 31y for receiving the pipe member 14y is provided. Further, at the two ends of the groove 31y, grooves 32y for receiving the engagement parts 34y of the later mentioned connecting member holder 19y are provided deeper than the groove 31y. Furthermore, inside the grooves 32y, recesses 33y for receiving locking projections 35y provided at the front ends of the connecting parts 34y of the later mentioned connecting member holders 19y are provided.

19y show PVDF connecting member holders provided at the two ends of the main body 18y. At first ends of the connecting member holders 19y, rectangular cross-section engagement parts 34y engaged with grooves 32y provided at the two ends of the main body 18y are formed. Furthermore, at the bottom parts of the front ends of the engagement parts 34y, locking projections 35y are provided to be engaged with recessed grooves 33y provided at the grooves 32y of the main body 18y. On the other hand, at the other ends, hexagonal cross-section sockets 36y are provided for receiving the same cross-sectional flange parts 43y of the later mentioned connecting members 20y. At the outer circumferential surfaces, male thread parts 37y are provided. At the outer circumferential surfaces positioned between the male thread parts 37y and the engagement parts 34y, ring-shaped flange parts 38y having diameters substantially the same as the diagonal lengths of the engagement parts 34y are provided. The flange parts 38y contact the cylinder main body 15y and the main body 18y and prevent the connecting member holders 19y from moving inside the two main bodies. Inside the connecting member holders 19y, through holes 39y having substantially the same diameters as the outside diameter of the pipe member 14y are provided at the engagement parts 34y. Further, connected with this, through holes 40y having substantially the same diameters as the outside diameter of the pipe member 14y engaged and expanded in the insertion parts 42y of the later mentioned connecting members 20y communicating with the sockets 36y is provided. Therefore, step parts 41y are formed at the inner circumferential surfaces of the connecting member holders 19y. The step parts 41y grip and fasten the pipe member 14y in the connecting member holders 19y.

20y show PTFE connecting members. At first ends of the connecting members 20y, insertion parts 42y are provided formed with outside diameters larger than the inside diameter of the pipe member 14y and having the pipe member 14y inserted into them expanded in diameter. At the center parts of the outer circumferences of the connecting members 20y, hexagonal cross-section flange parts 43y larger in diameter than the two ends are provided. The connecting members 20y are fastened by being engaged with the connecting members 19y so as not to rotate by engaging the flange parts 43y with the sockets 36y of the connecting member holders 19y and screwing cap nuts 44y engaged with the flange parts 43y over the male thread parts 37y provided at the outer circumferences of the connecting member holders 19y. Here, inside one of the connecting members 20y set at the two ends of the main body 18y, the inlet passage 45y is formed and is communicated with the outlet passage 179 of said flow rate measuring device 174. Further, inside the other connecting member 20y, an outlet passage 46y is formed. This becomes the later mentioned fluid outflow port 176.

Next, the fluid passing through the flow rate measuring device 174 flows into the fluid control valve 175. The control unit 177 outputs a signal to the electropneumatic converter 178 so as to make the difference between any set flow rate and the flow rate measured in real time zero. The electropneumatic converter 178 supplies control air having a corresponding operating pressure to the fluid control valve 175 to drive it. The fluid flowing out from the fluid control valve 175 is controlled by the fluid control valve 175 so that the flow rate becomes the set flow rate, that is, so the difference between the set flow rate and the measured flow rate is converged to zero.

Here, the operation of the fluid control valve 175 with respect to the operating pressure supplied from the electropneumatic converter 178 will be explained.

When supplying compressed air from the air port 28y to the second space 26y, the compressed air in the first space 25y is exhausted from the air port 27y. Due to the air pressure, the piston 16y starts to descend. Along with this, the compressor 17y also descends through a connecting part 29y provided suspended down from the piston 16y. When supplying compressed air from the air port 27y to the first cavity 25y, the compressed air in the second space 26y is exhausted from the air port 28y. Due to that air pressure, the piston 16y starts to rise. Along with this, the compressor 17y rises through the connecting part 29y provided suspended down from the piston 16y. Along with up and down movement of the piston 16y, the compressor 17y is also moved up and down, whereby the compressor 17y can change the opening area of the pipe member 14y and adjust the flow rate of the fluid flowing through the fluid control valve 175. Further, when supplying compressed air from the air port 28y to the second space 26y, the bottom end face of the piston 16y reaches the bottom of the cylinder part 21y and the descent of the piston 16y and compressor 17y stop, whereby the pipe member 14y can be closed and the fluid can be shut off.

Due to the above operation, the fluid flowing into the fluid inflow port 171 of the fluid control system 170 is controlled so as to become constant at a set flow rate and flows out from the fluid outflow port 176. Further, the fluid control valve 175 is compact and can stably control the flow rate due to the above configuration. The sliding part of the valve is separated from the passage, so it is possible to prevent contamination and the formation of particles inside the passage. The passage is straight and has no stagnating parts, so even if this is used for a line transporting a slurry, slurry will have a hard time sticking at the location controlling the flow rate, so stable fluid control can be maintained.

On the other hand, as shown in FIG. 13, 111 is a pressure adjustment value adjusting the pressure of the inflowing fluid to a constant pressure for outflow. The pressure adjustment valve 111 is formed by a main body 114, a lid 115, a first diaphragm 116, a second diaphragm 117, and a plug 118.

114 is a PVDF main body. It has a substantially cylindrical shape, is provided at the side surface with an inlet passage 113 communicated with the first valve chamber 120 provided inside the main body 114 and air feed port 121 communicated with the later mentioned air chamber 119, and has at the top peripheral edge of the first valve chamber 120 a connecting part 122 to which the ring-shaped projection 127 of the later mentioned first diaphragm 116 is connected. Further, the inlet passage 113 is communicated with the shutoff valve 172. Furthermore, at the top part of the first valve chamber 120, the later mentioned first and second diaphragms 116 and 117 and a step part 123 forming the later mentioned air chamber 119 are provided.

115 is a PVDF lid. It has a second valve chamber 124 at the inside and an outlet passage 112 communicating with the second valve chamber 124 at the outer circumferential side surface and is connected to the top end of the main body 114. Further, the outlet passage 112 is communicated with the flow rate measuring device 174. At the peripheral edge of the second valve chamber 124 at the bottom end, a ring-shaped groove 125 to which the ring-shaped projection 130w of the later mentioned second diaphragm 117 is engaged is provided.

116 is a PTFE first diaphragm. This is formed into a donut shape. At the center part, a ring-shaped connecting part 126 is formed sticking up to the later mentioned second diaphragm 117 side. At the inner circumferential surface of the ring-shaped connecting part 126, a sleeve 128 is screwed. Further, at the outer peripheral edge, a ring-shaped projection 127 is provided. The ring-shaped projection 127 is connected to the connecting part 122 provided inside the main body 114.

117 is a PTFE second diaphragm. At the center part, a ring-shaped connecting part 129 is provided. At the outer peripheral edge, a ring-shaped projection 130w is provided. The ring-shaped projection 130w is engaged with the ring-shaped groove 125 of the lid 115 and is clamped between the main body 114 and lid 115. Note that the second diaphragm 117 is formed so that the pressure receiving area becomes sufficiently larger than the first diaphragm 116. The first and second diaphragms 116 and 117 are joined by screwing with the sleeve 128.

The plug 118 is fastened to the bottom part of the first valve chamber 120 of the main body 114 by screwing etc. The front end of the plug 118 forms the fluid control unit 131w with the bottom end face of the sleeve 128. Along with vertical motion of the sleeve 128, the fluid control unit 131w changes in opening area. This is designed so that the pressure inside the second valve chamber 124, that is, the secondary side fluid pressure, is maintained constant at all times.

119 is an air chamber formed surrounded by the step part 123 of the main body 114 and the first and second diaphragms 116 and 117. Inside of the air chamber 119, compressed air is injected from an air feed port 121 and held at a constant pressure at all times.

Next, the operation of the pressure adjustment valve 111 will be explained.

The fluid first flows into the inlet passage 113 of the pressure adjustment valve 111. The pressure adjustment valve 111 is given a certain internal pressure by compressed air being supplied into the air chamber 119. The first diaphragm 116 receives the pressure inside the first valve chamber 120, that is, the upward direction force due to the primary side fluid pressure and the downward direction force due to the pressure inside the air chamber 119. On the other hand, the second diaphragm 117 receives the pressure inside the second valve chamber 124, that is, the downward direction force due to the secondary side fluid pressure and the upward direction force due to the pressure inside the air chamber 119. The balance of these four forces determines the position of the sleeve 128 where the first and second diaphragms 116 and 117 are connected. The sleeve 128 forms a fluid control unit 131w with the plug 118 and controls the secondary side fluid pressure by its area.

When the primary side fluid pressure rises in this state, the secondary side fluid pressure and flow rate also temporarily increase. At this time, the fluid pressure causes an upward direction force to act on the first diaphragm 116 and a downward direction force to act on the second diaphragm 117, but the second diaphragm 117 is designed so that the pressure receiving area becomes sufficiently large compared with the first diaphragm 116, so the downward direction force becomes larger and as a result the sleeve 128 is pushed downward. Due to this, the fluid control unit 131w is reduced in opening area, the secondary side fluid pressure instantaneously falls down to the original pressure, and the balance between the forces due to the internal pressure of the air chamber 119 and the fluid pressure is maintained.

On the other hand, when the primary side fluid pressure falls, the secondary side fluid pressure and flow rate also temporarily fall. At this time, the first and second diaphragms 116 and 117 are acted on by a downward direction and upward direction forces due to the internal pressure of the air chamber 119, but even in this case, the pressure receiving area of the second diaphragm 117 is larger, so the upward direction force becomes dominant and the position of the sleeve 128 is pushed upward. Due to this, the fluid control unit 131w increases in opening area, the secondary side fluid pressure instantly rises to the original pressure, the balance of forces due to the inside pressure of the air chamber 119 and the fluid pressure can be maintained, and the original flow rate can also be maintained.

Due to the above operation, even if the primary side fluid pressure of the pressure adjustment valve 111 changes, the position of the sleeve 128 instantaneously changes and the secondary side pressure is held constant. Therefore, even if the inflowing fluid pulsates, fluid reduced in pulsation flows from the outlet passage 112 to the flow rate measuring device 174. For this reason, the fluid control valve 175 can stably control the fluid without causing hunting even when the inflowing fluid is a pulsating flow with a short pressure fluctuation period. Further, the pressure adjustment valve 111 has a small number of parts and can be easily disassembled and assembled.

The pressure adjustment valve 111 of the present embodiment is configured simple in structure of the passage and resistant to stagnation of the fluid, so even if running slurry in the fluid, the slurry will be hard to stick and the pressure of the stably flowing fluid can be kept constant. Further, when the fluid is a slurry, work is performed periodically to run pure water so as to clean the inside of the passage. By running pure water through the pressure adjustment valve 111, the slurry which had slightly stuck to the inside walls of the pipeline is cleanly washed off. For this reason, even if the fluid is a slurry, long term use is possible. The rest of the configuration of the seventh embodiment is similar to that of the fourth embodiment, so the explanation will be omitted.

### Eighth Embodiment

Next, the operation of the fluid control system of an eighth embodiment of the present invention will be explained with reference to FIG. 14 and FIG. 15.

185 is a fluid control valve made variable in valve opening degree by a later mentioned electrical drive part 86w. The fluid control valve 185 is formed by an electrical drive part 86w, a main body 87w, a pipe member 88w, and a connecting part 89w.

87w is a PTFE main body. On the axial line of the passage of the main body 87w, a groove 90w of a rectangular cross-sectional shape receiving the later mentioned pipe member 88w is provided.

88w is pipe member comprised of a composite of a PTFE sheet and silicone rubber. A main body 87w has a passage formed in it.

89w shows PTFE connection parts. These are provided with connecting member holders 91w fastened to the two side surfaces of the lower bonnet 95w and the main body 87w by engagement with the groove 90w of the main body 87w and the bottom part of the lower bonnet 95w of the later mentioned electrical drive part 86w, connecting members 92w engaged with the connecting member holders 91w and connected to the pipe member 88w, and cap nuts 93w fastened to the connecting member holders 91w by screwing the connecting members 92w at the outer circumferential surfaces of the connecting member holders 91w. Here, the inside of one of the connecting members 92w set at the two ends of the main body 87w is formed with an inlet passage 101. This is communicated with the outlet passage 188 of said flow rate measuring device 184. Further, inside the other of the connecting members 92w, an outlet passage 102 is formed. This becomes the fluid outflow port 186.

86w is an electrical drive part for driving the compressor 94w up and down. The electrical drive part 86w is formed by a lower bonnet 95w and upper bonnet 96w and is provided with a motor part 97w and gear etc.

95w is a PVDF lower bonnet. It is provided with a recessed part 98 opening at the top surface. At the center of the bottom part of the recessed part 98, a through hole 99 is provided. Further, at a center of a bottom end surface of the lower bonnet 95w, an elliptical slit 100 is provided centered about the through hole 99.

96w is a PVDF upper bonnet. It is provided with a recessed part 103 opening at the bottom surface. The lower bonnet 95w and the upper bonnet 96w are joined together whereby the two recessed parts 98 and 103 form a housing 104 in which the later mentioned motor part 97w is set.

97w is a motor part set in a housing 104. The motor part 97w has a stepping motor. At the bottom of the motor part 97w, a stem 105 connected with the shaft of the motor is provided. The stem 105 is positioned at the through hole 99 of said lower bonnet 95w. At the bottom part of the stem 105, a compressor 94w is connected. Due to the drive operation of the motor part 97w, the stem 105 is made to move up and down whereby the compressor 94w presses against the pipe member 88w or moves away from the pipe member 88w.

94w is a compressor with a part pushing down the pipe member 88w formed into a loaf shaped cross-section. It is fastened to the stem 105 so as to perpendicularly intersect the pipe member 88w. At the time of full valve opening, it is housed in the elliptical slit 100 provided at the bottom end surface of the lower bonnet 95w.

The main body 87w of the fluid control valve 185 and the lower bonnet 95w and upper bonnet 96w of the electrical drive part 86w are connected by bolts and nuts (not shown).

Next, the fluid passing through the flow rate measuring device 184 flows into the fluid control valve 185. The control unit 187 outputs a signal for making the difference of any set flow rate with the flow rate measured in real time zero to the electrical drive part 86w. The electrical drive part 86w drives the compressor 94w of the fluid control valve 185 accordingly. The fluid flowing out from the fluid control valve 185 is controlled by the fluid control valve 185 so that the flow rate becomes the set flow rate, that is, so the difference between the set flow rate and measured flow rate is converged to zero.

Here, the operation of the fluid control valve 185 due to the transmission from the electrical drive part 86w will be explained. The flow rate control valve 185 can adjust the flow rate of the fluid flowing through the flow rate control valve 185 since if the motor part 97w of the electrical drive part 86w moves the stem 105 up and down, the compressor 94w provided at the bottom part of the stem 105 is moved up and down, the compressor 94w deforms the pipe member 88w, and the opening area of the passage of the pipe member 88w is changed. Further, if driving the stem 105 upward, the compressor 94w provided at the bottom part of the stem 105 rises, the top end of the compressor 94w reaches the top end surface of the elliptical slit provided at the bottom end of the lower bonnet 95w, and the rise and the stem 105 and compressor 94w is stopped and the fully opened state is reached. Furthermore, if driving the stem 105 downward, the compressor 94w descends, the pipe member 88w is pushed, and the passage is closed and fully closes.

Due to the above operation, the fluid flowing into the fluid inflow port 181 of the fluid control system 180 is controlled by the fluid control valve and flows out from the fluid outflow port 186 by the set flow rate. The fluid control valve of the present embodiment is configured as a pinch valve, so even if this is used for a line transporting a slurry, it will not obstruct the operation of the fluid control system 180. The slurry will also not clog the inside of the pipes, so the slurry can be used over a long period of time. The rest of the configuration of the eighth embodiment is similar to that of the second embodiment, so the explanation will be omitted.

### Ninth Embodiment

Next, a fluid control system 190 in the case where the flow rate measuring device is another ultrasonic flowmeter according to a ninth embodiment of the present invention will be explained with reference to FIG. 16.

234 is a flow rate measuring device measuring the flow rate of a fluid. The flow rate measuring device 234 has an inlet passage 235, a first rising passage 236 provided vertically from the inlet passage 235, a straight passage 237 communicated with the first rising passage 236 and provided substantially parallel with the axis of the inlet passage 235, a second rising passage 238 provided vertically from the straight passage 237, and an outlet passage 239 communicating with the second rising passage 238 and provided substantially parallel with the axis of the inlet passage 235. At positions where the side walls of the first and second rising passages 236 and 238 intersect the axis of the straight passage 237, ultrasonic oscillators 240 and 241 are arranged facing each other. The ultrasonic oscillators 240 and 241 are covered by a fluororesin. Wires extending from said oscillators 240 and 241 are connected to a processor 245 of the later mentioned control part 244. Note that the parts other than the ultrasonic oscillators 240 and 241 of the flow rate measuring device 234 are made of PFA. The inlet passage 235 is communicated with the shutoff valve 242, while the outlet passage 239 is communicated with the fluid control valve 243. The rest of the configuration of the ninth embodiment is similar to that of the fourth embodiment, so the explanation will be omitted.

Next, the operation of the fluid control system 190 of the ninth embodiment of the present invention will be explained.

The fluid flowing into the fluid control system passes through the shutoff valve 242 and flows into the flow rate measuring device 234. The fluid flowing into the flow rate measuring device 234 is measured for flow rate in the straight passage 237. The ultrasonic vibration is propagated from the ultrasonic oscillator 240 positioned at the upstream side in the flow of the fluid toward the ultrasonic oscillator 241 positioned at the downstream side. The ultrasonic vibration received at the ultrasonic oscillator 241 is converted to an electrical signal and output to the processor 245 of the control part 244. When the ultrasonic vibration is propagated from the upstream side ultrasonic oscillator 240 and received by the downstream side ultrasonic oscillator 241, the processor 245 instantaneously switches transmission and reception so that ultrasonic vibration is propagated from the ultrasonic oscillator 241 positioned at the downstream side to the ultrasonic oscillator 240 positioned at the upstream side. The ultrasonic vibration received by the ultrasonic oscillator 240 is converted into an electrical signal and output to the processor 245 in the control part 244. At this time, the ultrasonic vibration is propagated against the flow of the fluid in the straight passage 237, so compared with when the ultrasonic vibration is propagated from the upstream side to the downstream side, the speed of propagation of the ultrasonic vibration in the fluid is slower and the propagation time becomes longer. The output electrical signals are used to measure the propagation times in the processor 245 and the flow rate is calculated from the difference in propagation times. The flow rate calculated by the processor 245 is converted to an electrical signal which is then output to the control part 246. The rest of the operation of the ninth embodiment is similar to that of the fourth embodiment, so an explanation will be omitted.

### 10th Embodiment

Next, a fluid control system 200 for the case where the flow rate measuring device is an ultrasonic type vortex flowmeter according to a 10th embodiment of the present invention will be explained with reference to FIG. 17 and FIG. 18.

247 is a flow rate measuring device. The flow rate measuring device 247 has a straight passage 251 provided with an inlet passage 248, a vortex generator 249 provided vertically in the inlet passage 248 and generating a Karman vortex, and an outlet passage 250. At the side walls of the straight passage 251 downstream of the vortex generator 249, ultrasonic oscillators 252 and 253 are arranged facing each other at positions perpendicular to the passage axial direction. The ultrasonic oscillators 252 and 253 are covered by a fluororesin. The wires extending from said oscillators 252 and 253 are connected to the processor of the control part 256. Everything but the ultrasonic oscillators 252 and 253 of the flow rate measuring device 247 are made of PTFE. The inlet passage 248 is communicated with a shutoff valve 254, while the outlet passage 250 is communicated with a fluid control valve 255. The rest of the configuration of the 10th embodiment is similar to that of the fourth embodiment, so the explanation will be omitted.

Next, the operation of the fluid control system of the 10th embodiment of the present invention will be explained.

The fluid flowing into the fluid control system passes through the shutoff valve 254 and flows into the flow rate measuring device 247. The fluid flowing into the flow rate measuring device 247 is measured for flow rate in the straight passage 251. Ultrasonic vibration is propagated through the fluid flowing through the inside of the straight passage 251 from the ultrasonic oscillator 252 toward the ultrasonic oscillator 253. The Karman vortex generated downstream of the vortex generator 249 is generated at a period proportional to the flow rate of the fluid. Karman vortexes of different swirl directions are alternately generated, so the ultrasonic vibration is accelerated or decelerated in the direction of progression when passing through the Karman vortex due to the swirl direction of the Karman vortex. For this reason, the ultrasonic vibration received by the ultrasonic oscillator 253 fluctuates in frequency (period) due to the Karman vortexes. The ultrasonic vibration sent and received by the ultrasonic oscillators 252 and 253 are converted to electrical signals and output to the processor 257 of the control part 256. At the processor 257, the flow rate of the fluid flowing through the straight passage 251 is calculated based on the frequency of the Karman vortex obtained from the phase difference of the ultrasonic vibration output from the transmitting side ultrasonic oscillator 252 and the ultrasonic vibration output from the receiving side ultrasonic oscillator 253. The flow rate calculated by the processor 257 is converted to an electrical signal and output to the control part 258. The rest of the operation of the 10th embodiment is similar to that of the fourth embodiment, so an explanation will be omitted.

Due to the above operation, the ultrasonic type vortex flowmeter can accurately measure the flow rate even with a large flow rate since the greater the flow rate, the more vortexes are generated and exhibits a superior effect in fluid control of a large flow rate.

Note that the present invention was explained in detail based on specific embodiments, but a person skilled in the art could make various changes, modifications, etc. without departing from the claims and ideas of the present invention.

1. A fluid control system characterized by being provided with:
a fluid control valve changing an opening area of a passage so as to control a flow rate of a fluid,
a flow rate measuring device measuring a flow rate of the fluid, converting a measurement value of said flow rate to an electrical signal, and outputting it, and
a control part outputting a command signal for controlling an opening area of said fluid control valve to said fluid control valve or a piece of equipment operating said fluid control valve based on a difference between the electrical signal from the flow rate measuring device and a set flow rate.

2. A fluid control system as set forth in claim 1, characterized by being further provided with a shutoff valve for opening or cutting off the flow of the fluid.

3. A fluid control system as set forth in claim 2, characterized by being further provided with a pressure adjustment valve reducing pressure fluctuations of said fluid.

4. A fluid control system as set forth in claim 3, characterized in that said valves and said flow rate measuring device are directly connected without using independent connecting means.

5. A fluid control system as set forth in claim 4, characterized in that said valves and said flow rate measuring device are arranged in a single base block.

6. A fluid control system as set forth in claim 4, characterized in that said fluid control valve is provided with a main body having a valve chamber at its top part and an inlet passage and outlet passage communicating with the valve chamber and provided with an opening part to which the inlet passage is communicated at the center of the bottom part of the valve chamber, a cylinder provided with a through hole at the center of the bottom part and a breathing hole at a side surface and clamping and fastening the main body and first diaphragm, and a bonnet provided with a working fluid communication port at the top part and clamping and fastening the cylinder and the peripheral edge of the second diaphragm all fastened integrally; the first diaphragm is formed integrally by a shoulder part, a mounting part positioned on the shoulder part and fastened by engagement with a bottom part of a later mentioned rod, a connecting part positioned below the shoulder part and to which a later mentioned valve element is fastened, a thin film part extending in the radial direction from the shoulder part, a thick part following the thin film part, and a seal part provided at the peripheral edge of the thick part, the connecting part having fastened to it a valve element emerging and retracting along with up and down motion of a later mentioned rod at the opening part of the valve chamber; on the other hand, the second diaphragm has a center hole, is integrally formed with a thick part around it and thin film part extending from the thick part in the radial direction and a seal part provided at the peripheral edge of the thin film part, and is clamped and fastened passing through the center hole by a diaphragm holder at a shoulder part positioned at the top part of the rod to which the mounting part of the first diaphragm is fastened at the bottom part; and further the rod has a bottom part arranged in a loosely engaged state inside the through hole at the bottom part of the cylinder and is supported by a spring engaged in a state preventing movement in the radial direction between the step part of the cylinder and the shoulder part of the rod.

7. A fluid control system as set forth in claim 4, characterized in that Further, said fluid control valve is comprised of a flow rate control unit provided with an electrical drive part having a motor part enclosed by an upper bonnet and lower bonnet, a diaphragm having a valve element moved up and down by a stem connected to a shaft of the motor part, and a main body having an inlet passage and outlet passage separated from the electrical drive part by a diaphragm and communicated with the valve chamber.

8. A fluid control system as set forth in claim 4, characterized in that said fluid control valve is provided with a pipe member comprised of an elastic member, a cylinder main body having an internal cylinder part and having a cylinder lid connected to its top part, a piston able to slide up and down at the inner circumferential surface of the cylinder part in a sealing state and having a connecting part provided suspended down from the center so as to pass through a through hole provided in the center of the bottom surface of the cylinder main body in a sealing state, a compressor fastened to a bottom end of the connecting part of the piston and housed in an elliptical slit provided perpendicularly intersecting the passage axis at the bottom surface of the cylinder main body, a main body connected and fastened to the bottom end face of the cylinder main body and provided with a first groove for receiving the pipe member on the passage axis and second grooves receiving a connecting member holder at the two ends of the first groove and deeper than the first groove, a pair of connecting member holders each having an engagement part for engagement with a second groove of the main body at one end, having a connecting member socket inside another end, and having a through hole for receiving a pipe member, and a pair of air ports provided at the peripheral side surfaces of the cylinder main body and communicating with a first space formed surrounded by the bottom surface and inner circumferential surface of the cylinder part and the bottom end surface of the piston and a second space formed surrounded by the bottom end surface of the cylinder, the inner circumferential surface of the cylinder part, and the top surface of the piston.

9. A fluid control system as set forth in claim 4, characterized in that said fluid control valve is provided with an electrical drive part having a motor part enclosed by an upper bonnet and lower bonnet, a compressor driven up and down by a stem connected to a shaft of the motor part, a pipe member comprised of an elastic member, and a groove connected and fastened to a lower end face of the lower bonnet and housing a pipe member on a passage axis.

10. A fluid control system as set forth in claim 4, characterized in that said pressure control valve is provided with a main body having a second cavity provided at a center of the bottom part and opening at a base part, an inlet passage communicating with the second cavity, a first cavity provided at a top part with a top face open and having a diameter larger than a diameter of the second cavity, an outlet passage communicating with the first cavity, and a communicating hole communicating the first cavity and second cavity and having a diameter smaller than the diameter of the first cavity, a top face of the second cavity made a valve seat; a bonnet having inside it a cylindrical cavity communicating with an air feed hole and exhaust hole provided at a side face or top face and provided with a step part at an inner circumference of a bottom end; a spring retainer inserted into the step part of the bonnet and having a through hole at its center; a piston having at its bottom end a first connecting part with a smaller diameter than the through hole of the spring retainer, provided at its top part with a flange, and inserted inside the cavity of the bonnet to be vertically movable; a spring supported gripped by a bottom end face of the flange of the piston and a top end face of the spring retainer; a first valve mechanism having a first diaphragm having a peripheral edge fastened by being gripped between the main body and the spring retainer and having a center part forming a first valve chamber in a manner capping the first cavity of the main body made thick, a second connecting part provided at the center of its top face passing through the through hole of the spring retainer and fastened by being connected to the first connecting part of the piston, and a third connecting part provided at the center of its bottom face passing through the communicating hole of the main body; a second valve mechanism having a valve element positioned inside the second cavity of the main body and provided in a larger diameter than the communicating hole of the main body, a fourth connecting part provided sticking out at the top end face of the valve element and being fastened by being connected with the third connecting part of the first valve mechanism, a rod provided sticking out from a bottom end face of the valve element, and a second diaphragm provided extending out from the bottom end face of the rod in the radial direction; and a baseplate positioned below the main body, having at the center of its top part a projecting part fastening the peripheral edge of the second diaphragm of the second valve mechanism by gripping it with the main body, provided with a cut recess at a top end of the projecting part, and provided with a breathing hole communicating with the cut recess; an opening area of a fluid control part formed by the valve element of the second valve mechanism and the valve seat of the main body changing along with vertical motion of the piston.

11. A fluid control system as set forth in claim 4, characterized in that said pressure adjustment valve is comprised of a main body having inside it a first valve chamber, a step part provided at the top part of the first valve chamber, and an inlet passage communicating with the first valve chamber; a lid having a second valve chamber and an outlet passage communicating with the same and connected to the top part of the main body; a first diaphragm with a peripheral edge connected to the upper peripheral edge of the first valve chamber; a second diaphragm with a peripheral edge clamped by the main body and lid; a sleeve connected to two ring-shaped connecting parts provided at the centers of the first and second diaphragms and able to move freely in the axial direction; and a plug fastened to the bottom part of the first valve chamber and forming a fluid control unit with the bottom end of the sleeve; there is an air chamber surrounded by an inner circumferential surface of the step part of the main body and the first and second diaphragms; a pressure receiving area of the second diaphragm is formed larger than a pressure receiving area of the first diaphragm; and an air supply communicating with said air chamber is provided at the main body.

12. A fluid control system as set forth in claim 4, characterized in that said flow rate measuring device is an ultrasonic flowmeter or ultrasonic type vortex flowmeter.
